(19) United States
(12) Patent Application Publication
(10) Pub. No.: US 2011/0043639 A1
(43) Pub. Date: Feb. 24, 2011

(54) Image Sensing Apparatus And Image Processing Apparatus

(75) Inventor: Masahiro YOKOHATA, Osaka City (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/859,895

(22) Filed: Aug. 20, 2010

(30) Foreign Application Priority Data
Aug. 20, 2009 (JP) 2009-191072
Jul. 1, 2010 (JP) 2010-150739

(51) Int. Cl. H04N 5/228; G06K 9/00

(52) U.S. Cl. 348/169; 382/103; 348/E05.024

(57) ABSTRACT

An image sensing apparatus includes an imaging unit which outputs image data of images obtained by photography, and a photography control unit which controls the imaging unit to perform sequential photography of a plurality of target images including a specific object as a subject. The photography control unit sets a photography interval of the plurality of target images in accordance with a moving speed of the specific object.

### CROSS-REFERENCE TO RELATED APPLICATIONS

This nonprovisional application claims priority under 35 U.S.C. §119(a) on Patent Application No. 2009-191072 filed in Japan on Aug. 20, 2009 and on Patent Application No. 2010-150739 filed in Japan on Jul. 1, 2010, the entire contents of which are hereby incorporated by reference.

### BACKGROUND OF THE INVENTION

1. Field of the Invention

The present invention relates to an image sensing apparatus such as a digital still camera or a digital video camera, and an image processing apparatus which performs image processing on an image.

2. Description of Related Art

As illustrated in FIG. 19, so-called frame advance images (top forwarding images) noting a specific subject can be obtained by performing sequential photography (continuous shooting) of a photography target including the specific subject having a motion. In addition, there is proposed a method of generating a so-called stroboscopic image by cripping a specific subject image part from each of a plurality of taken images and by combining them.

In this case, if a sequential photography interval that is an photography interval between temporally neighboring taken images is appropriate, images of the specific subject at different photography time points are arranged at an appropriate position interval on a taken image sequence and the stroboscopic image. However, when the sequential photography interval is too short, as illustrated in FIG. 20, positional change of the specific subject between the different photography time points is so small that positional change of the specific subject between neighboring taken images becomes small, and that images of the specific subject at different photography time points on the stroboscopic image are overlapped with each other. On the contrary, if the sequential photography interval is too long, as illustrated in FIG. 21, positional change of the specific subject between different photography time points is so large that the specific subject may not be included in an image that is taken at later time point, and as a result, the number of the specific subjects on the stroboscopic image may be decreased.

In a first conventional method, slit frames for dividing a photography region into a plurality of regions are displayed on the display unit, and guides a photographer to press a shutter button at timings when the specific subject exists in individual slit frames, so as to obtain the taken image sequence in which the images of the specific subject are arranged at an appropriate position interval. However, in this conventional method, the photographer is required to decide whether or not the specific subject exists in each of the slit frames so that the photographer presses the shutter button at appropriate timings. Therefore, a large load is put on the photographer, and the photographer may often let the appropriate timing for pressing the shutter button slip away.

On the other hand, there is proposed another method in which a frame image sequence is taken at a constant frame rate and is recorded in a recording medium, and in a reproduction process, images of a subject part having a motion are extracted from the recorded frame image sequence and combined.

In a second conventional method, only partial images extracted from frame images that are partial images of the subject having a motion larger than a predetermined level from the previous frame image are combined in decoding order. However, in this method, if a speed of the specific subject to be noted is small, it is decided that the motion of the specific subject between neighboring frame images is not the motion larger than the predetermined level, so that the specific subject is excluded from a target of combination (as a result, a stroboscopic image noting the specific subject cannot be generated).

In addition, as to the above-mentioned first conventional method, in a method of reproduction, as illustrated in FIG. 22, a first frame image 901 among the stored frame image sequence is used as a reference. Difference images between the first frame image 901 and other images, i.e., the frame images 902 and 903 are generated. Then, positions of the dynamic regions 911 and 912 that are image regions with the generated differences are determined. In FIG. 22, and in FIG. 23 that will be referred to later, black regions in the difference images are dynamic regions. In the first conventional method, it is decided that the image in the dynamic region 911 on the frame image 902 is the image of the specific subject, and it is decided that the image in the dynamic region 912 on the frame image 903 is the image of the specific subject. In FIG. 22, only two dynamic regions based on three frame images are illustrated, but actually, positions of two or more dynamic regions based on many frame images are determined. After that, a plurality of slit frames are set on the combined image, and dynamic regions fit in the slit frames are selected. The images in the selected dynamic regions are sequentially overwritten on the combined image, so as to complete a combined image on which the specific subject images are arranged equally. This method is effective in the situation as illustrated in FIG. 22, specifically, in the situation where one dynamic region corresponds to only the specific subject at one photography time point.

As to the first conventional method, in the method of reproduction, a so-called background image in which there is no specific subject having a motion (image like the frame image 901) is necessary.

With reference to FIG. 23, an operation of the first conventional method when there is no background image will be described. As illustrated in FIG. 23, if a first frame image of the stored frame image sequence is an image 921 including the specific subject, a dynamic region based on a difference between the frame image 921 and a second frame image 922 is like a region 931 illustrated in FIG. 23, and a dynamic region based on a difference between the frame image 921 and a third frame image 923 is like a region 932 illustrated in FIG. 23. The dynamic region 931 corresponds to a region as a combination of regions of the specific subject on the frame images 921 and 922, and the dynamic region 932 corresponds to a region as a combination of regions of the specific subject on the frame images 921 and 923. If the dynamic region 931 is obtained, it is decided that the image in the dynamic region 931 on the frame image 922 is the image of the specific subject for performing a combination process (the same is true for the dynamic region 932). Since this decision is not correct, the obtained combined image is very different from a desired image. Specifically, in the situation illustrated in FIG. 23, the assumption that one dynamic region corresponds to only the specific subject at one photography time point is not satisfied, so that the generation method of the combined image in the first conventional method does not function effectively. Although the conventional method is described above supposing that a plurality of images to be targets of the combining process or the like are obtained by the sequential photography, but the same is true also in the case where they are obtained by taking a moving image.

### SUMMARY OF THE INVENTION

A first image sensing apparatus according to the present invention includes an imaging unit which outputs image data of images obtained by photography, and a photography control unit which controls the imaging unit to take sequentially a plurality of target images including a specific object as a subject. The photography control unit sets a photography interval of the plurality of target images in accordance with a moving speed of the specific object.

A second image sensing apparatus according to the present invention includes an imaging unit which outputs image data of images obtained by photography, and a photography control unit which controls the imaging unit to take sequentially a plurality of frame images including a specific object as a subject. The photography control unit includes a target image selection unit which selects a plurality of target images from the plurality of frame images on the basis of a moving speed of the specific object.

A first image processing apparatus according to the present invention includes an image selection unit which selects p selected images from m input images among a plurality of input images obtained by sequential photography including a specific object as a subject (m and p denote an integer of two or larger, and m>p holds), the image selection unit selects the p selected images including i-th and the (i+1)th selected images so that a distance between the specific object on the i-th selected image and the specific object on the (i+1)th selected image becomes larger than a reference distance corresponding to a size of the specific object (i denotes an integer in a range from one to (p−1)).

A third image sensing apparatus according to the present invention includes an imaging unit which outputs image data of images obtained by photography, a sequential photography control unit which controls the imaging unit to perform sequential photography of a plurality of target images including a specific object as a subject, and an object characteristic deriving unit which detects a moving speed of the specific object on the basis of image data output from the imaging unit before the plurality of target images are photographed. The sequential photography control unit sets a sequential photography interval of the plurality of target images in accordance with the detected moving speed.

A second image processing apparatus according to the present invention includes an image selection unit which selects p selected images from m input images obtained by sequential photography including a specific object as a subject (m and p denote an integer of two or larger, and m>p holds), and an object detection unit which detects a position and a size of the specific object on each input image via a tracking process for tracking the specific object on the m input images on the basis of image data of each input image. The image selection unit selects the p selected images including i-th and the (i+1)th selected images so that a distance between the specific object on the i-th selected image and the specific object on the (i+1)th selected image based on a detection result of position by the object detection unit is larger than a reference distance corresponding to the size of the specific object on the i-th and the (i+1)th selected images based on a detection result of size by the object detection unit (i denotes an integer in a range from one to (p−1)).

Meanings and effects of the present invention will be apparent from the following description of embodiments. However, the embodiments described below are merely examples of the present invention, and meanings of the present invention and terms of elements thereof are not limited to those in the embodiments described below.

### BRIEF DESCRIPTION OF THE DRAWINGS

FIG. 1 is a general block diagram of an image sensing apparatus according to a first embodiment of the present invention.

FIG. 2 is a diagram illustrating a two-dimensional coordinate system (image space) of a spatial domain in which any two-dimensional image is disposed.

FIG. 3 is a diagram illustrating a manner in which stroboscopic image is generated from a plurality of target images according to the first embodiment of the present invention.

FIG. 4 is a diagram illustrating a relationship between a preview image sequence and a target image sequence according to the first embodiment of the present invention.

FIG. 5 is a block diagram of a portion related particularly to an operation of a special sequential photography mode in the first embodiment of the present invention.

FIG. 6 is a diagram illustrating a manner in which a tracking target region is set in the preview image or the target image according to the first embodiment of the present invention.

FIG. 7 is a diagram illustrating a method of deriving a moving speed of the tracking target from positions of the tracking target in two preview images according to the first embodiment of the present invention.

FIG. 8 is a diagram illustrating a method of deriving a subject size (average size of the tracking target) from sizes of the tracking target on two preview images according to the first embodiment of the present invention.

FIG. 9 is a diagram illustrating a deriving method of a movable distance of the tracking target performed by a sequential photography possibility decision unit illustrated in FIG. 5.

FIG. 10 is a diagram illustrating a deriving method of an estimated moving distance of the tracking target performed by the sequential photography possibility decision unit illustrated in FIG. 5.

FIG. 11 is an operational flowchart of the image sensing apparatus in the special sequential photography mode according to the first embodiment of the present invention.

FIGS. 12A, 12B and 12C are diagrams illustrating display images that are displayed in the case where it is decided that the sequential photography cannot be performed according to the first embodiment of the present invention.

FIG. 13 is a block diagram of a portion related particularly to an operation of a special reproduction mode according to a second embodiment of the present invention.

FIG. 14 is a diagram illustrating a frame image sequence according to the second embodiment of the present invention.

FIG. 15 is a diagram illustrating a display image when the tracking target is set according to the second embodiment of the present invention.

FIG. 16 is a diagram illustrating tracking targets and tracking target regions on two frame images in a common image space (on a common paper sheet) according to the second embodiment of the present invention.

FIG. 17 is a diagram illustrating a stroboscopic image according to the second embodiment of the present invention.

FIG. 18 is an operational flowchart of the image sensing apparatus in the special reproduction mode according to the second embodiment of the present invention.

FIG. 19 is a diagram illustrating a taken image sequence and a stroboscopic image based on them according to the conventional method.

FIG. 20 is a diagram illustrating another taken image sequence and a stroboscopic image based on them according to a conventional method.

FIG. 21 is a diagram illustrating still another taken image sequence and a stroboscopic image based on them according to the conventional method.

FIG. 22 is a diagram illustrating a manner in which a dynamic region is extracted from a difference between frame images according to a conventional method.

FIG. 23 is a diagram illustrating a manner in which a dynamic region is extracted from a difference between frame images according to a conventional method.

FIG. 24 is a diagram illustrating a structure of a moving image according to a third embodiment of the present invention.

FIG. 25 is a block diagram of a portion related particularly to an operation of a third embodiment of the present invention.

FIG. 26 is a diagram illustrating a relationship among three target frame images and a stroboscopic moving image according to the third embodiment of the present invention.

FIG. 27 is an operational flowchart of an image sensing apparatus according to the third embodiment of the present invention.

FIG. 28 is an operational flowchart of an image sensing apparatus according to the third embodiment of the present invention.

FIG. 29 is a diagram illustrating a structure of a moving image according to a fourth embodiment of the present invention.

FIG. 30 is a block diagram of a portion related particularly to an operation according to the fourth embodiment of the present invention.

FIGS. 31A, 31B and 31C are diagrams illustrating a manner in which target frame images are selected from target frame image candidates according to the fourth embodiment of the present invention.

FIG. 32 is an operational flowchart of an image sensing apparatus according to the fourth embodiment of the present invention.

FIG. 33 is a diagram illustrating a structure of a moving image according to the fifth embodiment of the present invention.

FIG. 34 is a diagram illustrating meaning of an estimated moving distance of the tracking target according to the fifth embodiment of the present invention.

FIG. 35 is an operational flowchart of an image sensing apparatus according to the fifth embodiment of the present invention.

### DETAILED DESCRIPTION OF THE PREFERRED EMBODIMENTS

Hereinafter, embodiments of the present invention will be described with reference to attached drawings. In the referred drawings, the same portion is denoted by the same numeral or symbol, so that overlapping description of the same portion is omitted as a rule.

### First Embodiment

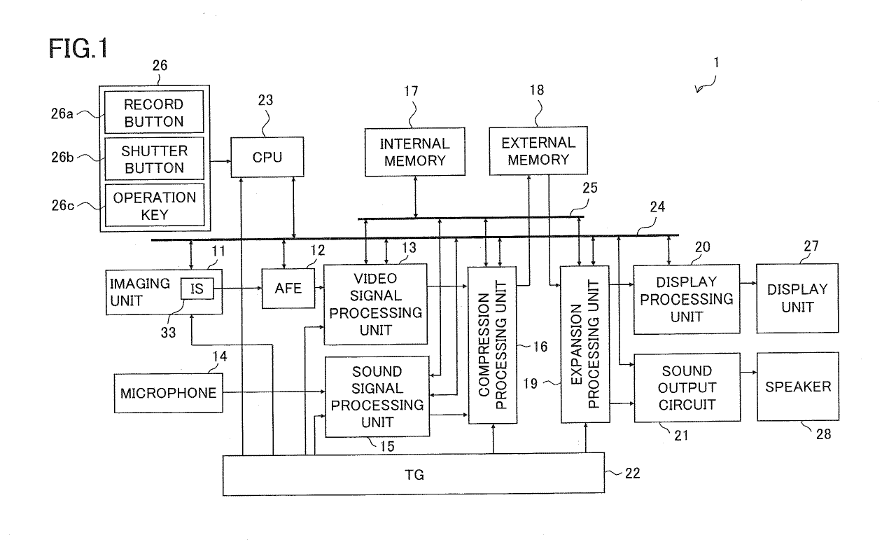

A first embodiment of the present invention will be described. FIG. 1 is a general block diagram of an image sensing apparatus 1 according to the first embodiment of the present invention. The image sensing apparatus 1 includes individual units denoted by numerals 11 to 28. The image sensing apparatus 1 is a digital video camera and is capable of taking moving images and still images, and is also capable of taking a still image simultaneously while taking a moving image. Each unit in the image sensing apparatus 1 sends and receives a signal (data) between individual units via a bus 24 or 25. Note that a display unit 27 and/or a speaker 28 may be provided to external device (not shown) of the image sensing apparatus 1.

The imaging unit 11 is equipped with an image sensor 33 as well as an optical system, an aperture stop and a driver that are not shown. The image sensor 33 is constituted of a plurality of light receiving pixels arranged in the horizontal and the vertical directions. The image sensor 33 is a solid-state image sensor constituted of a charge coupled device (CCD), a complementary metal oxide semiconductor (CMOS) image sensor or the like. Each light receiving pixel of the image sensor 33 performs photoelectric conversion of an optical image of a subject entering through the optical system and the aperture stop, and an electric signal obtained by the photoelectric conversion is output to an AFE (analog front end) 12. Individual lenses constituting the optical system form an optical image of the subject on the image sensor 33.

The AFE 12 amplifies an analog signal output from the image sensor 33 (each light receiving pixel), and converts the amplified analog signal into a digital signal, which is output to an video signal processing unit 13 from the AFE 12. An amplification degree of the signal amplification in the AFE 12 is controlled by a CPU (central processing unit) 23. The video signal processing unit 13 performs necessary image processing on an image expressed by the output signal of the APE 12, so as to generate an video signal of the image after the image processing. A microphone 14 converts sounds around the image sensing apparatus 1 into an analog sound signal, and a sound signal processing unit 15 converts the analog sound signal into a digital sound signal.

A compression processing unit 16 compresses the video signal from the video signal processing unit 13 and the sound signal from the sound signal processing unit 15 by using a predetermined compression method. An internal memory 17 is constituted of a dynamic random access memory (DRAM) or the like for temporarily storing various data. An external memory 18 as a recording medium is a nonvolatile memory such as a semiconductor memory or a magnetic disk, which records the video signal and the sound signal after the compression process performed by the compression processing unit 16, in association with each other.

An expansion processing unit 19 expands the compressed video signal and sound signal read from the external memory 18. The video signal after the expansion process performed by the expansion processing unit 19 or the video signal from the video signal processing unit 13 are sent via a display processing unit 20 to the display unit 27 constituted of a liquid crystal display or the like and is displayed as an image. In addition, the sound signal after the expansion process performed by the expansion processing unit 19 is sent via a sound output circuit 21 to the speaker 28 and is output as sounds.

A timing generator (TG) 22 generates a timing control signal for controlling timings of operations in the entire image sensing apparatus 1, and the generated timing control signal is imparted to individual units in the image sensing apparatus 1. The timing control signal includes a vertical synchronizing signal Vsync and a horizontal synchronizing signal Hsync. The CPU 23 integrally controls operations of individual units in the image sensing apparatus 1. An operating unit 26 includes a record button 26a for instructing start and stop of taking and recording a moving image, a shutter button 26b for instructing to take and record a still image, an operation key 26c and the like, for receiving various operations performed by a user. The contents of operation to the operating unit 26 are transmitted to the CPU 23.

Operation modes of the image sensing apparatus 1 include a photography mode in which images (still images or moving images) can be taken and recorded, and a reproduction mode in which images (still images or moving images) recorded in the external memory 18 are reproduced and displayed on the display unit 27. In accordance with the operation to the operation key 26c, a transition between modes is performed. The image sensing apparatus 1 operating in the reproduction mode functions as an image reproduction apparatus.

In the photography mode, photography of a subject is performed sequentially so that taken images of the subject are sequentially obtained. The digital video signal expressing an image is also referred to as image data.

Note that compression and expansion of the image data are not relevant to the essence of the present invention. Therefore, in the following description, compression and expansion of the image data are ignored (i.e., for example, recording of compressed image data is simply referred to as recording of image data). Further, in this specification, image data of certain image may be simply referred to as an image.

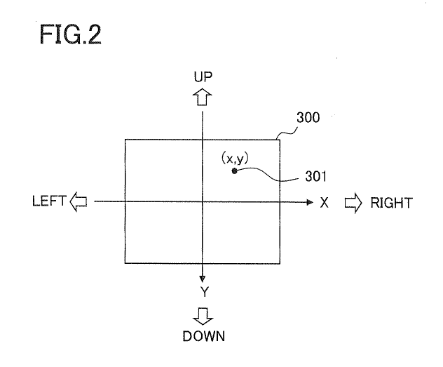

As illustrated in FIG. 2, a two-dimensional coordinate system XY of a spatial domain is defined, in which any two-dimensional image 300 is disposed. The two-dimensional coordinate system XY can be said as an image space. The image 300 is, for example, the taken image described above, a stroboscopic image, a preview image, a target image or a frame image that will be described later. The X axis and Y axis are axes along the horizontal direction and the vertical direction of the two-dimensional image 300. The two-dimensional image 300 is constituted of a plurality of pixels arranged like a matrix in the horizontal direction and the vertical direction, a position of a pixel 301 as any pixel on the two-dimensional image 300 is expressed by (x,y). In this specification, a position of a pixel is also referred to as a pixel position, simply. Symbols x and y respectively denote coordinate values in the X axis direction and the Y axis direction of the pixel 301. In the two-dimensional coordinate system XY, when a position of a pixel is shifted to the right side by one pixel, a coordinate value of the pixel in the X axis direction is increased by one. When a position of a pixel is shifted downward by one pixel, a coordinate value of the pixel in the Y axis direction is increased by one. Therefore, when a position of the pixel 301 is (x,y), positions of pixels neighboring to the pixel 301 on the right side, the left side, the lower side and the upper side are denoted by (x+1,y), (x−1,y), (x,y+1) and (x,y−1), respectively.

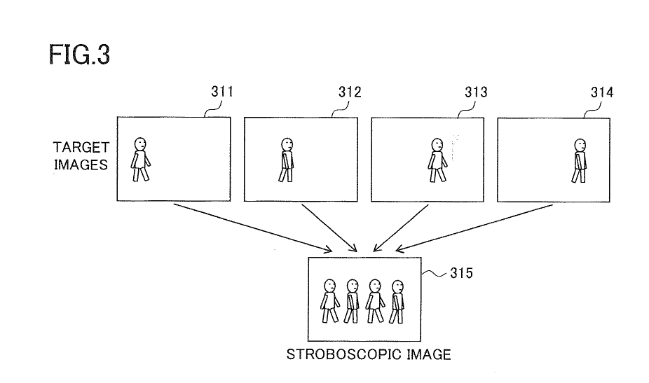

As one type of the photography mode of the image sensing apparatus 1, there is a special sequential photography mode. In the special sequential photography mode, as illustrated in FIG. 3, a plurality of taken images in which noted specific subject is disposed at a desirable position interval (images 311 to 314 in the example illustrated in FIG. 3) are obtained by the sequential photography. Taken images obtained by the sequential photography in the special sequential photography mode are referred to as a target images in the following description. A plurality of target images obtained by the sequential photography are combined so as to generate a stroboscopic image on which specific subjects on the individual target images are expressed on one image. An image 315 in FIG. 3 is a stroboscopic image based on the images 311 to 314.

The user can set the operation mode of the image sensing apparatus 1 to the special sequential photography mode by performing a predetermined operation to the operating unit 26. Hereinafter, in the first embodiment, an operation of the image sensing apparatus 1 in the special sequential photography mode will be described.

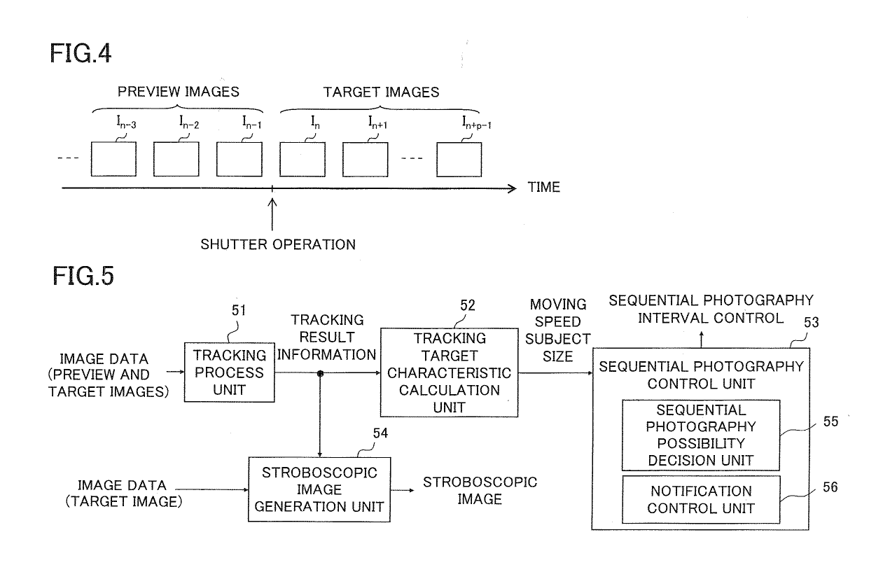

FIG. 4 is a diagram illustrating images constituting an image sequence taken in the special sequential photography mode. The image sequence means a set of a plurality of still images arranged in time sequence. The shutter button 26b is constituted to be capable of a two-step pressing operation. When the user presses the shutter button 26b lightly, the shutter button 26b becomes a half-pressed state. When the shutter button 26b is further pressed from the half-pressed state, the shutter button 26b becomes a fully pressed state. The operation of pressing the shutter button 26b to the fully pressed state is particularly referred to as shutter operation. When the shutter operation is performed in the special sequential photography mode, sequential photography of p target images is performed (i.e., p target images are taken sequentially) right after that. Symbol p denotes two or larger integer. The user can determine the number of target images (i.e., a value of p) freely.

Target images taken first, second, . . . , and p-th order among the p target images are denoted by symbols Iₙ, Iₙ₊₁, . . . , and Iₙ₊ₚ₋₁, respectively (n is an integer). A taken image obtained by photography before taking the first target image Iₙ is referred to as a preview image. The preview image is taken sequentially at a constant frame rate (e.g., 60 frames per second (fps)). Symbols I₁ to Iₙ₋₁ are assigned to the preview image sequence. As illustrated in FIG. 4, it is supposed that as time elapses, the preview images I₁, I₂, Iₙ₋₃, Iₙ₋₂, and Iₙ₋₁ are taken in this order, and the target image Iₙ is taken next after the preview image Iₙ₋₁ is taken. The preview image sequence is displayed as a moving image on the display unit 27, so that the user confirms the display image while checking execution timing of the shutter operation.

FIG. 5 is a block diagram of a portion related particularly to an operation of the special sequential photography mode incorporated in the image sensing apparatus 1. Each unit illustrated in FIG. 5 is realized by the CPU 23 or the video signal processing unit 13 illustrated in FIG. 1. For instance, a tracking process unit (object detection unit) 51 and a stroboscopic image generation unit (image combination unit) 54 can be mounted in the video signal processing unit 13, and a tracking target characteristic calculation unit (object characteristic deriving unit) 52 and a sequential photography control unit 53 can be disposed in the CPU 23. The sequential photography control unit 53 is equipped with a sequential photography possibility decision unit 55 and a notification control unit 56.

The tracking process unit 51 performs a tracking process for tracking on an input moving image a noted object on an input moving image on the basis of image data of the input moving image. Here, the input moving image means a moving image constituted of the preview image sequence including the preview images I₁ to Iₙ₋₁ and the target image sequence including the target images Iₙ to The noted object is a noted subject of the image sensing apparatus 1 when the input moving image is taken. The noted object to be tracked in the tracking process is referred to as a tracking target in the following description.

The user can specify the tracking target. For instance, the display unit 27 is equipped with a so-called touch panel function. Further, when the preview image is displayed on the display screen of the display unit 27, the user touches a display region in which the noted object is displayed on the display screen, so that the noted object is set as the tracking target. Alternatively, for example, the user can specify the tracking target also by a predetermined operation to the operating unit 26. Further, alternatively, it is possible that the image sensing apparatus 1 automatically sets the tracking target by using a face recognition process. Specifically, for example, a face region that is a region including a human face is extracted from the preview image on the basis of image data of the preview image, and then it is checked by the face recognition process whether or not a face included in the face region matches a face of a person enrolled in advance. If matching is confirmed, the person having the face included in the face region may be set as the tracking target.

Further, alternatively, it is possible to set the moving object on the preview image sequence automatically to the tracking target. In this case, a known method may be used so as to extract the moving object to be set as the tracking target from an optical flow between two temporally neighboring preview images. The optical flow is a bundle of motion vectors indicating direction and amplitude of a movement of an object on an image.

For convenience sake of description, it is supposed that the tracking target is set on the preview image I₁ in the following description. After the tracking target is set, the position and size of the tracking target is sequentially detected on the preview images and the target images in the tracking process on the basis of image data of the input moving image. Actually, an image region in which image data indicating the tracking target exists is set as the tracking target region in each preview image and each target image, and a center position and a size of the tracking target region is detected as the position and size of the tracking target. The image in the tracking target region set in the preview image is a partial image of the preview image (the same is true for the target image and the like). A size of the tracking target region detected as the size of the tracking target can be expressed by the number of pixels belonging to the tracking target region. Note that it is possible to replace the term “center position” in the description of each embodiment of the present invention with “barycenter position”.

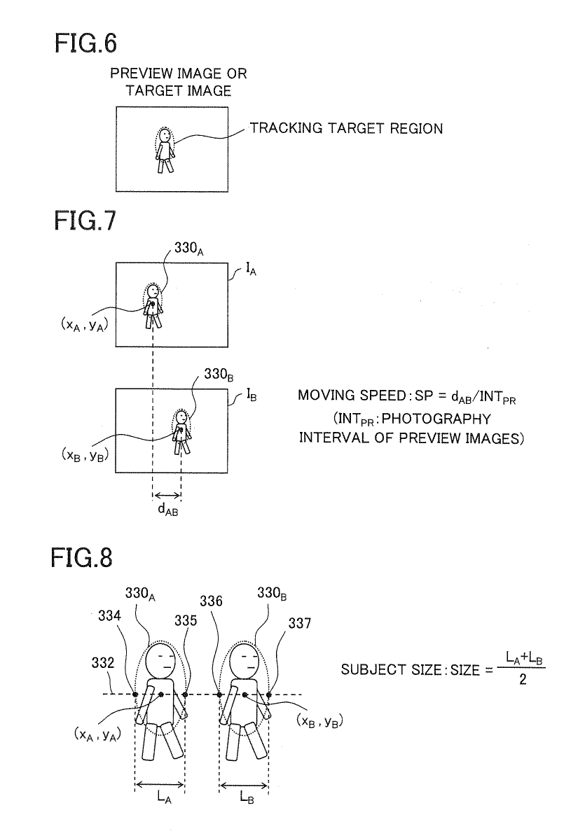

The tracking process unit 51 outputs tracking result information including information indicating the position and size of the tracking target in each preview image and each target image. It is supposed that a shape of the tracking target region is also defined by the tracking result information. For instance, although it is different from the situation illustrated in FIG. 6 as described later, if the tracking target region is a rectangular region, coordinate values of two apexes of a diagonal of the rectangular region should be included in the tracking result information. Alternatively, coordinate values of one apex of the rectangular region and size of the rectangular region in the horizontal and vertical directions should be included in the tracking result information.

The tracking process between the first and the second images to be calculated can be performed as follows. Here, the first image to be calculated means a preview image or a target image in which the position and size of the tracking target are already detected. The second image to be calculated means a preview image or a target image in which the position and size of the tracking target are to be detected. The second image to be calculated is usually an image that is taken after the first image to be calculated.

For instance, the tracking process unit 51 can perform the tracking process on the basis of image characteristics of the tracking target. The image characteristics include luminance information and color information. More specifically, for example, a tracking frame that is estimated to have the same order of size as a size of the tracking target region is set in the second image to be calculated, and a similarity evaluation between image characteristics of an image in the tracking frame on the second image to be calculated and image characteristics of an image in the tracking target region on the first image to be calculated is performed while changing a position of the tracking frame in a search region. Then, it is decided that the center position of the tracking target region in the second image to be calculated exists at the center position of the tracking frame having the maximum similarity. The search region with respect to the second image to be calculated is set on the basis of a position of the tracking target in the first image to be calculated.

After the center position of the tracking target region in the second image to be calculated is determined, a closed region enclosed by an edge including the center position can be extracted as the tracking target region in the second image to be calculated by using a known contour extraction process or the like. Alternatively, an approximation of the closed region may be performed by a region having a simple figure shape (such as a rectangle or an ellipse) so as to extract the same as the tracking target region. In the following description, it is supposed that the tracking target is a person and that the approximation of the tracking target region is performed by an ellipse region including a body and a head of the person as illustrated in FIG. 6.

Note that it is possible to adopt any other method different from the above-mentioned method as the method of detecting position and size of the tracking target on the image (e.g., it is possible to adopt a method described in JP-A-2004-94680 or a method described in JP-A-2009-38777).

The tracking target characteristic calculation unit 52 calculates, on the basis of the tracking result information of the tracking process performed on the preview image sequence, moving speed SP of the tracking target on the image space and a subject size (object size) SIZE in accordance with the size of the tracking target on the image space. The moving speed SP functions as an estimated value of the moving speed of the tracking target on the target image sequence, and the subject size SIZE functions as an estimated value of the size of the tracking target on each target image.

The moving speed SP and the subject size SIZE can be calculated on the basis of the tracking result information of two or more preview images, i.e., positions and sizes of the tracking target region on two or more preview images.

A method of calculating the moving speed SP and the subject size SIZE from the tracking result information of two preview images will be described. The two preview images for calculating the moving speed SP and the subject size SIZE are denoted by I_{A} and I_{B}. The preview image I_{B} is a preview image taken at time as close as possible to a photography time point of the target image Iₙ, and the preview image I_{A} is a preview image taken before the preview image I_{B}. For instance, the preview images I_{A} and I_{B} are the preview images Iₙ₋₂ and Iₙ₋₁, respectively. However, it is possible to set the preview images I_{A} and I_{B} to the preview images Iₙ₋₃ and Iₙ₋₁, respectively, or to the preview images Iₙ₋₃ and Iₙ₋₂, respectively, or to other preview images. In the following description, it is supposed that preview images I_{A} and I_{B} are the preview images Iₙ₋₂ and Iₙ₋₁, respectively, unless otherwise stated.

The moving speed SP can be calculated in accordance with the equation (1) below, from a center position (x_{A},y_{A}) of the tracking target region on the preview image I_{A} and a center position (x_{B},y_{B}) of the tracking target region on the preview image I_{B}. As illustrated in FIG. 7, symbol d_{AB} denotes a distance between the center positions (x_{A},y_{A}) and (x_{B},y_{B}) on the image space. In FIG. 7, and in FIG. 8 that will be referred to later, an ellipse-like region enclosed by broken lines 330_{A} and 330_{B} are tracking target regions on the preview images I_{A} and I_{B}, respectively. Symbol INT_{PR} denotes a photography interval between the preview images I_{A} and I_{B}. As described above, since the preview images I_{A} and I_{B} are preview images Iₙ₋₂ and Iₙ₋₁, INT_{PR} is a photography interval between neighboring preview images, i.e., an inverse number of a frame rate of the preview image sequence. Therefore, when a frame rate of the preview image sequence is 60 frames per second (fps), INT_{PR} is 1/60 seconds.

SP=d_{AB}/INT_{PR} (1)

On the other hand, the subject size SIZE can be calculated from a specific direction size L_{A} of the tracking target region in the preview image I_{A} and a specific direction size L_{B} of the tracking target region in the preview image I_{B}. FIG. 8 is a diagram illustrating a tracking target region 330_{A} on the preview image I_{A} and a tracking target region 330_{B} on the preview image I_{B} in the same image space (two-dimensional coordinate system XY). A straight line 332 connecting the center positions (x_{A},y_{A}) and (x_{B},y_{B}) crosses a contour of the tracking target region 330_{A} at intersection points 334 and 335, and the straight line 332 crosses a contour of the tracking target region 330_{B} at intersection points 336 and 337. A distance between the intersection points 334 and 335 is determined as the specific direction size L_{A}, and a distance between the intersection points 336 and 337 is determined as the specific direction size L_{B}. Then, an average value of the specific direction sizes L_{A} and L_{B} is substituted for the subject size SIZE.

A method of calculating the moving speed SP and the subject size SIZE by using the tracking result information of the preview images I_{A} and I_{B} that are the preview images Iₙ₋₂ and as well as the tracking result information of the preview image I_{C} that is the preview image Iₙ₋₃ will be described. In this case, the moving speed SP can be calculated in accordance with the equation SP=(d_{CA}+d_{AB})/(2·INT_{PR}). Here, d_{CA} denotes a distance between the center positions (x_{C},y_{C}) and (x_{A},y_{A}) on the image space, and the center position (x_{C},y_{C}) is a center position of the tracking target region in the preview image I_{C}. In addition, positions of two intersection points at which the straight line connecting the center positions (x_{C},y_{C}) and (x_{A},y_{A}) crosses the contour of the tracking target region 330_{C} on the preview image I_{C} are specified, and a distance between the two intersection points is determined as the specific direction size L_{C}, so that an average value of the specific direction sizes L_{A}, L_{B} and L_{C} can be determined as a subject size SIZE. Also in the case where the moving speed SP and the subject size SIZE are calculated from the tracking result information of four or more preview images, they can be calculated in the same manner.

The moving speed SP (an average moving speed of the tracking target) and the subject size SIZE (an average size of the tracking target) determined by the method described above is sent to the sequential photography control unit 53.

The sequential photography control unit 53 sets the sequential photography interval INT_{TGT} in photography of the target image sequence in accordance with the equation, (sequential photography interval INT_{TGT})=(target subject interval α)/(moving speed SP), more specifically, in accordance with the equation (2) below.

INT_{TGT}=α/SP (2)

The sequential photography interval INT_{TGT} means an interval between photography time points of two temporally neighboring target images (e.g., Iₙ and Iₙ₊₁). The photography time point of the target image Iₙ means, in a strict sense, for example, a start time or a mid time of exposure period of the target image Iₙ (the same is true for the target image Iₙ₊₁ and the like).

The target subject interval α indicates a target value of a distance between center positions of tracking target regions on the two temporally neighboring target images. Specifically, for example, a target value of a distance between the center position (xₙ,yₙ) of the tracking target region on the target image Iₙ and the center position (xₙ₊₁,yₙ₊₁) of the tracking target region on the target image Iₙ₊₁ is the target subject interval α. The sequential photography control unit 53 determines the target subject interval α in accordance with the subject size SIZE. For instance, the target subject interval α is determined from the subject size SIZE so that “α=SIZE” or “α=k₀×SIZE” or “α=SIZE+k₁” is satisfied. Symbols k₀ and k₁ are predetermined coefficients. However, it is possible to determine the target subject interval α in accordance with user's instruction. In addition, it is possible that the user determines values of the coefficients k₀ and k₁.

The sequential photography control unit 53 controls the imaging unit 11 in cooperation with the TG 22 (see FIG. 1) so that the sequential photography of p target images is performed at the sequential photography interval INT_{TGT} as a rule after the sequential photography interval INT_{TGT} is set, thereby p target images in which tracking targets are arranged at a substantially constant position interval are obtained. However, there is a case where such p target images cannot be obtained depending on the position of the tracking target or the like when the sequential photography is started.

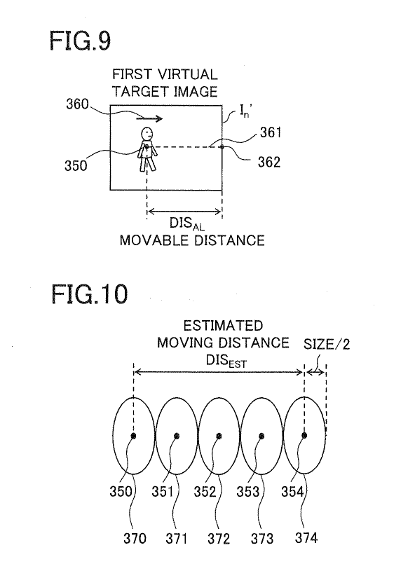

Therefore, the sequential photography possibility decision unit 55 (see FIG. 5) included in the sequential photography control unit 53 decides sequential photography possibility of the p target images prior to the sequential photography of the p target images. For concrete description, it is supposed that p is five, and the decision method will be described with reference to FIGS. 9 and 10. An image Iₙ′ illustrated in FIG. 9 is a virtual image of the first target image Iₙ (hereinafter referred to as a virtual target image). The virtual target image Iₙ′ is not an image that is obtained by an actual photography but an image that is estimated from the tracking result information. A position 350 is a center position of the tracking target region on the virtual target image Iₙ′. An arrow 360 indicates a movement direction of the tracking target on the image space. The movement direction 360 agrees with the direction from the above-mentioned center position (x_{A},y_{A}) to the center position (x_{B},y_{B}) (see FIGS. 7 and 8) or the direction from the center position (x_{C},y_{C}) to the center position (x_{B},y_{B}).

The position 350 is a position shifted from the center position of the tracking target region on the preview image Iₙ₋₁ in the movement direction 360 by a distance (SP×INT_{PR}). Here, however, it is supposed that a time difference between photography time points of the preview image Iₙ₋₁ and the target image Iₙ is equal to the photography interval INT_{PR} of the preview images.

The sequential photography possibility decision unit 55 calculates a movable distance DIS_{AL} of the tracking target on the target image sequence on the assumption that the tracking target moves in the movement direction 360 at the moving speed SP on the target image sequence during a photography period of the target image sequence. A line segment 361 extending from the position 350 in the movement direction 360 is defined, and an intersection point 362 of the line segment 361 and the contour of the virtual target image Iₙ′ is determined. A distance between the position 350 and the intersection point 362 is calculated as the movable distance DIS_{AL}.

On the other hand, the sequential photography possibility decision unit 55 estimates a moving distance DIS_{EST} of the tracking target on the image space (and on the target image sequence) during the photography period of the p target images. FIG. 10 is referred to. In FIG. 10, five positions 350 to 354 are illustrated in the common image space. The position 350 in FIG. 10 is the center position of the tracking target region on the virtual target image Iₙ′ as described above. In FIG. 10, the solid line ellipse regions 370, 371, 372, 373 and 374 including the positions 350, 351, 352, 353 and 354, respectively, are estimated tracking target regions on the target images Iₙ, Iₙ₊₁, Iₙ₊₂, Iₙ₊₃ and Iₙ₊₄. Sizes and shapes of the estimated tracking target regions 370 to 374 are the same as those of the tracking target region on the preview image Iₙ₋₁.

The positions 351, 352, 353 and 354 are estimated center positions of the tracking target region on the target images Iₙ₊₁, Iₙ₊₂, Iₙ₊₃ and Iₙ₊₄, respectively. The position 351 is a position shifted from the position 350 in the movement direction 360 by the target subject interval α. The positions 352, 353 and 354 are positions shifted from the position 350 in the movement direction 360 by (2×α), (3×α) and (4×α), respectively.

The sequential photography possibility decision unit 55 estimates a distance between the positions 350 and 354 as the moving distance DIS_{EST}. Specifically, the moving distance DIS_{EST} is estimated on the assumption that the tracking target moves in the movement direction 360 by the moving speed SP on the target image sequence during the photography period of the target image sequence. Since p is five, an estimation equation (3) of the moving distance DIS_{EST} is as follows (see the above-mentioned equation (2)).

DIS_{EST}=(4×α)=α×(p−1)=INT_{TGT}×SP×(p−1) (3)

Only in the case where it is estimated that the entire tracking target region is included in each of p (five in this example) target images, the sequential photography possibility decision unit 55 decides that the sequential photography of p target images can be performed. Otherwise, it is decided that the sequential photography of p target images cannot be performed. As understood also from FIG. 10, when the decision expression (4) is satisfied, it is decided that the sequential photography can be performed. If the decision expression (4) is not satisfied, it is decided that the sequential photography cannot be performed. However, considering a margin, the decision expression (5) may be used instead of the decision expression (4) (Δ×>0).

DIS_{AL}≧DIS_{EST}+SIZE/2 (4)

DIS_{AL}≧DIS_{EST}+SIZE/2+Δ (5)

If the sequential photography possibility decision unit 55 decides that the sequential photography cannot be performed, the notification control unit 56 (FIG. 5) notifies the user of the information of the decision result by sound or video output.

In the following description, it is supposed that the sequential photography possibility decision unit 55 decides that the sequential photography of p target images can be performed, and that the entire tracking target region (i.e., the entire image of the tracking target) is included in each of the actually taken p target images, unless otherwise stated.

The stroboscopic image generation unit 54 generates the stroboscopic image by combining images in the tracking target regions of the target images Iₙ to Iₙ₊ₚ₋₁ on the basis of tracking result information for the target images Iₙ to Iₙ₊ₚ₋₁ and image data of the target images Iₙ to Iₙ₊ₚ₋₁. The generated stroboscopic image can be recorded in the external memory 18. Note that the target images Iₙ to Iₙ₊ₚ₋₁ can also be recorded in the external memory 18.

Specifically, images in the tracking target regions on the target images Iₙ₊₁ to Iₙ₊ₚ₋₁ are extracted from the target images Iₙ₊₁ to Iₙ₊ₚ₋₁ on the basis of the tracking result information for the target images Iₙ₊₁ to Iₙ₊ₚ₋₁, and the images extracted from the target images Iₙ₊₁, Iₙ₊₂, . . . Iₙ₊ₚ₋₁ are sequentially overwritten on the target image Iₙ, so that a stroboscopic image like the stroboscopic image 315 illustrated in FIG. 3 is generated. Thus, if the tracking target moves in the movement direction 360 at the moving speed SP actually on the target image sequence during the photography period of the target image sequence, the common tracking targets on the target images Iₙ to Iₙ₊ₚ₋₁ are disposed on the stroboscopic image in a distributed manner at the target subject interval α.

Alternatively, it is possible to extract images in the tracking target regions on the target images Iₙ to Iₙ₊ₚ₋₁ from the target images Iₙ to Iₙ₊ₚ₋₁ on the basis of the tracking result information for the target images Iₙ to Iₙ₊ₚ₋₁, and to prepare a background image such as a white image or a black image so as to sequentially overwrite the images extracted from the target images Iₙ, Iₙ₊₁, Iₙ₊₂, . . . Iₙ₊ₚ₋₁ on the background image for generating the stroboscopic image.

It is also possible to generate the stroboscopic image without using the tracking result information for the target images. For instance, when p is five, images in the regions 371 to 374 illustrated in FIG. 10 may be extracted from the target images Iₙ₊₁ to Iₙ₊₄, respectively, and the images extracted from the target images Iₙ₊₁ to Iₙ₊₄ may be sequentially overwritten on the target image Iₙ so as to generate the stroboscopic image. Alternatively, images in the regions 370 to 374 illustrated in FIG. 10 may be extracted from the target images Iₙ to Iₙ₊₄, respectively, and the images extracted from the target images Iₙ to Iₙ₊₄ may be sequentially overwritten on the background image so as to generate the stroboscopic image.

<<Operational Flow>>

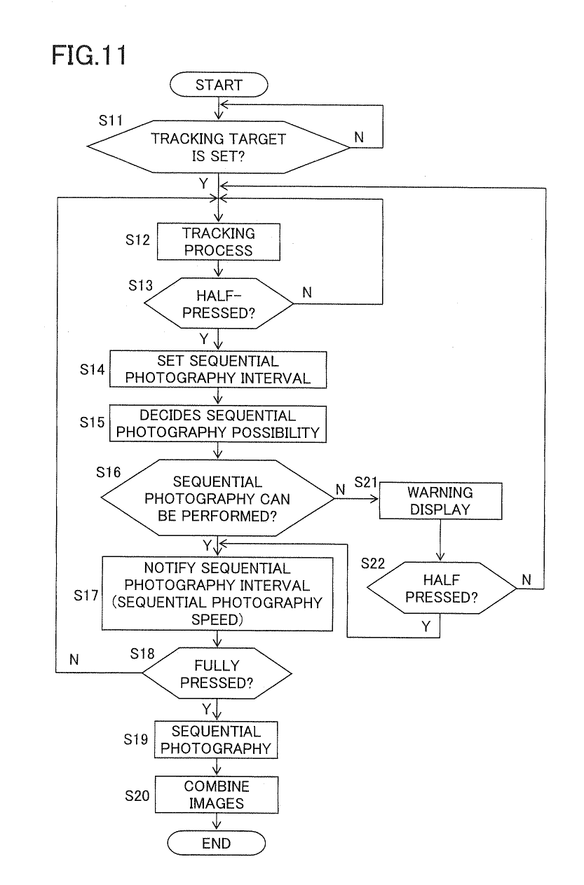

Next, with reference to FIG. 11, a flow of the operation of the image sensing apparatus 1 in the special sequential photography mode will be described. FIG. 11 is a flowchart illustrating the operational flow. First, in Step S11, it is waited that the tracking target is set. When the tracking target is set, the process goes from Step S11 to Step S12, in which the above-mentioned tracking process is started. After the tracking target is set, the tracking process is performed continuously in other steps than Step S12.

After the tracking process is started, it is checked in Step S13 whether or not the shutter button 26b is in the half-pressed state. When it is checked that the shutter button 26b is in the half-pressed state, the moving speed SP and the subject size SIZE are calculated on the basis of the latest tracking result information (tracking result information of two or more preview images) obtained at that time point, and then setting of the sequential photography interval INT_{TGT} and decision of the sequential photography possibility by the sequential photography possibility decision unit 55 are performed (Steps S14 and S15).

When the sequential photography possibility decision unit 55 decides that the sequential photography can be performed (Y in Step S16), the notification control unit 56 notifies information corresponding to the sequential photography interval INT_{TGT} to the outside of the image sensing apparatus 1 in Step S17. This notification is performed by using visual or hearing means so that the user can recognize the information. Specifically, for example, intermittent electronic sound is output from the speaker 28. When the sequential photography interval INT_{TGT} is relatively short, an output interval of the electronic sound is set to a relatively short value (e.g., sound pi-pi-pi is output from the speaker 28 in 0.5 seconds). When the sequential photography interval INT_{TGT} is relatively long, an output interval of the electronic sound is set to a relatively long value (e.g., sound pi-pi-pi is output from the speaker 28 in 1.5 seconds). It is possible to display an icon or the like corresponding to the sequential photography interval INT_{TGT} on the display unit 27. The notification in Step S17 enables the user to recognize a sequential photography speed of the sequential photography that will be performed after that and to estimate overall photography time of the target image sequence. As a result, it is possible to avoid a situation where the user changes the photography direction or turns off the power of the image sensing apparatus 1 during the photographing operation of the target image sequence in mistake that the photography of the target image sequence is finished.

After the notification in Step S17, it is checked whether or not the shutter button 26b is in a fully-pressed state in Step S18. If the shutter button 26b is not in the fully-pressed state, the process goes back to Step S12. If the shutter button 26b is in the fully-pressed state, the sequential photography of p target images is performed in Step S19. Further, also in the case where it is checked during the notification in Step S17 that the shutter button 26b is fully-pressed state, the process goes promptly to Step S19 in which the sequential photography of p target images is performed.

As the sequential photography interval INT_{TGT} of the of p target images that is taken sequentially in Step S19, the one set in Step S14 can be used. However, it is possible to recalculate the moving speed SP and the subject size SIZE and to reset the sequential photography interval INT_{TGT} by using the tracking result information for a plurality of preview images (e.g., preview images Iₙ₋₂ and Iₙ₋₁) including the latest preview image obtained at the time point when the fully-pressed state of the shutter button 26b is confirmed, and to perform the sequential photography in Step S19 in accordance with the reset sequential photography interval INT_{TGT}.

In Step S20 following the Step S19, the stroboscopic image is generated from the p target images obtained in Step S19.

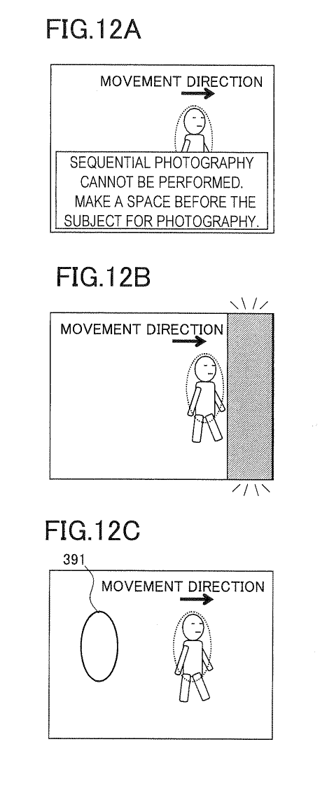

If the sequential photography possibility decision unit 55 decides that the sequential photography cannot be performed (N in Step S16), the process goes to Step S21 in which a warning display is performed. Specifically, for example, in Step S21, as illustrated in FIG. 12A, a sentence meaning that the sequential photography of the target image sequence cannot be performed at an optimal subject interval (target subject interval α) is displayed on the display unit 27 (the sentence is displayed in an overlaid manner on the latest preview image). Alternatively, for example, in Step S21, as illustrated in FIG. 12B, a display region on the movement direction side of the tracking target (corresponding to a hatched region in FIG. 12B) may be blinked so as to inform the user that the sequential photography of the target image sequence cannot be performed at an optimal subject interval (this blink is performed on the latest preview image displayed on the display unit 27). Further, alternatively, for example, in Step S21, as illustrated in FIG. 12C, a recommended tracking target position may be displayed in an overlaid manner on the latest preview image displayed on the display unit 27. In FIG. 12C, a frame 391 indicates the recommended tracking target position. The frame 391 is displayed at an appropriate position so that the sequential photography of the target image sequence can be performed at an optimal subject interval when the shutter operation is performed in the state where the photography direction is adjusted so that the tracking target exists in the frame 391. The display position of the frame 391 can be determined by using the moving distance DIS_{EST} and the subject size SIZE.

In Step S22 following the Step S21, it is checked whether or not the shutter button 26b is maintained to be the half-pressed state. If the half-pressed state of the shutter button 26b is canceled, the process goes back to Step S12. If the half-pressed state of the shutter button 26b is not canceled, the process goes to Step S17. When the process goes from Step S22 to Step S17, and then the shutter button 26b becomes the fully-pressed state, the sequential photography of p target images is performed. However, in this case, there is a case where the tracking target is not included in a target image that is taken at later timing (e.g., target image Iₙ₊ₚ₋₁). Therefore, the number of tracking targets on the stroboscopic image generated in Step S20 becomes smaller than p with high probability.

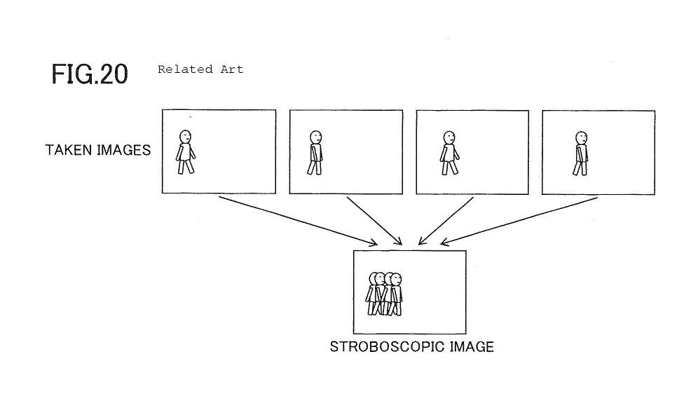

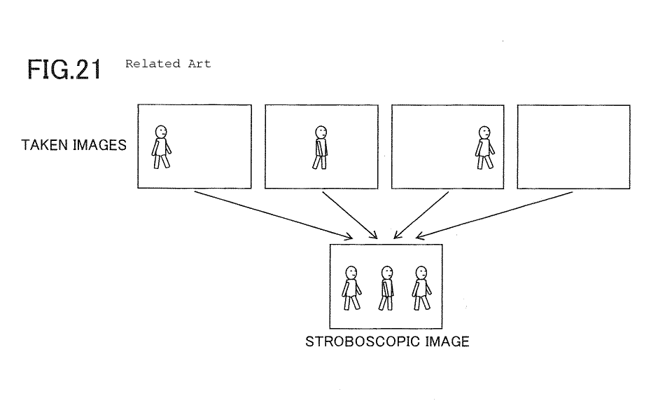

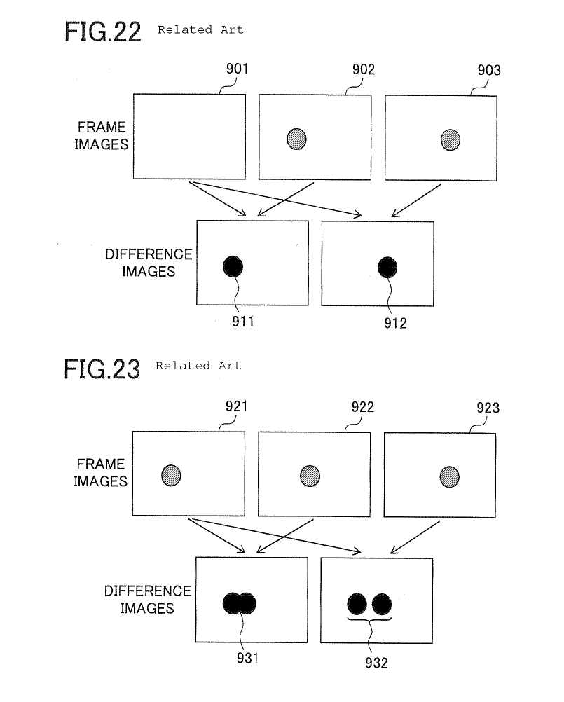

According to this embodiment, the sequential photography interval is optimized so that the tracking target is arranged at a desired position interval in accordance with a moving speed of the tracking target. Specifically, it is possible to adjust the position interval between tracking targets at different time points to a desired value. As a result, for example, it is possible to avoid overlapping of tracking targets at different time points on the stroboscopic image (see FIG. 20). In addition, it is also possible to avoid a situation where the tracking target is not included in a target image that is taken at later timing (e.g., target image Iₙ₊ₚ₋₁) (see FIG. 21), or a situation where a target image sequence with a small positional change of the tracking target is taken (see FIG. 20).

Further, the stroboscopic image is generated from p target images in this embodiment, but the generation of the stroboscopic image is not essential. The p target images have a function as so-called frame advance images (top forwarding images) noting the tracking target. In the case where the p target images are noted, the action and the effect of adjusting the position interval between tracking targets at different time points to a desired one is realized.

### Second Embodiment

A second embodiment of the present invention will be described. An image sensing apparatus according to the second embodiment is also the image sensing apparatus 1 illustrated in FIG. 1 similarly to the first embodiment. In the second embodiment, a unique operation of the image sensing apparatus 1 in the reproduction mode will be mainly described. One type of the reproduction mode for realizing the unique operation is referred to as a special reproduction mode.

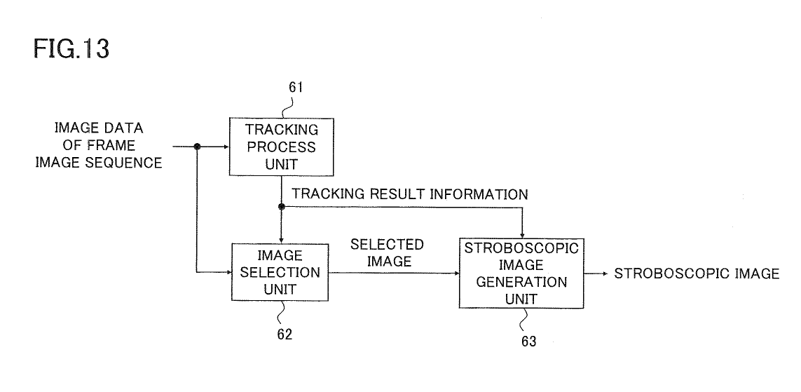

FIG. 13 is a block diagram of a portion related particularly to an operation of the special reproduction mode included in the image sensing apparatus 1. Each portion illustrated in FIG. 13 is realized by the CPU 23 or the video signal processing unit 13 illustrated in FIG. 1. For instance, the tracking process unit (object detection unit) 61 and the stroboscopic image generation unit (image combination unit) 63 can be mounted in the video signal processing unit 13, and the CPU 23 may function as the image selection unit 62.

The tracking process unit 61 illustrated in FIG. 13 has the same function as the tracking process unit 51 in the first embodiment. However, in contrast that the tracking process unit 51 in the first embodiment detects the position and size of the tracking target region on the preview image or the target image, the tracking process unit 61 detects the position and size of the tracking target region on each frame image forming the frame image sequence by the tracking process. Here, the frame image sequence means an image sequence taken by the photography mode prior to the operation of the special reproduction mode. More specifically, the image sequence obtained by the sequential photography performed by the imaging unit 11 at a predetermined frame rate is stored in the external memory 18 as the frame image sequence, and in the special reproduction mode the image data of the frame image sequence is read out from the external memory 18. By supplying the read image data to the tracking process unit 61, the tracking process can be performed for the frame image sequence. Note that the frame rate in the photography of the frame image sequence is usually a constant value, but it is not necessary that the frame rate is constant.

The tracking process unit 61 performs the tracking process on each frame image in accordance with the method described above in the first embodiment after the tracking target is set, so as to generate the tracking result information including information indicating the position and size of the tracking target region on each frame image. The generation method of the tracking result information is the same as that described above in the first embodiment. The tracking result information generated by the tracking process unit 61 is sent to the image selection unit 62 and the stroboscopic image generation unit 63.

The image selection unit 62 selects and extracts a plurality of frame images from the frame image sequence as a plurality of selected images on the basis of the tracking result information from the tracking process unit 61, so as to send image data of each selected image to the stroboscopic image generation unit 63. The number of the selected images is smaller than the number of frame images forming the frame image sequence.

The stroboscopic image generation unit 63 generates the stroboscopic image by combining images in the tracking target regions of the selected images based on the tracking result information for each selected image and image data of each selected image. The generated stroboscopic image can be recorded in the external memory 18. The generation method of the stroboscopic image by the stroboscopic image generation unit 63 is the same as that of the stroboscopic image generation unit 54 according to the first embodiment except for that a name of the image to be a base of the stroboscopic image is different between the stroboscopic image generation units 63 and 54.

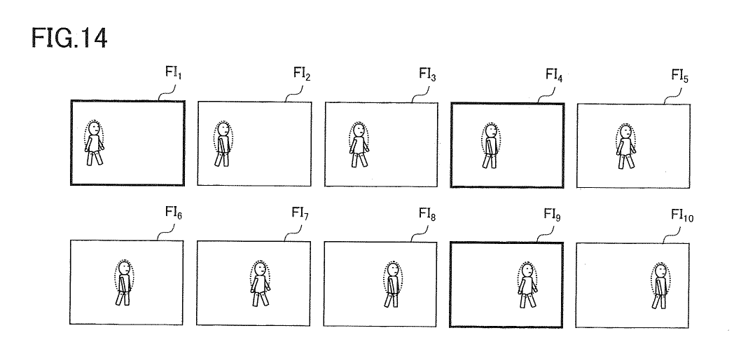

Now, supposing that the frame image sequence read out from the external memory 18 is constituted of ten frame images FI₁ to FI₁₀ illustrated in FIG. 14, a extraction method and the like of the selected image will be described in detail. A frame image FIᵢ₊₁ is an image taken next after the frame image FIᵢ (i denotes an integer), and image data of the frame images FI₁ to FI₁₀ are supplied to the tracking process unit 61 in the time sequential order. Further, in FIG. 14, outer frames of the frame images to be extracted as selected images in an example described later (FI₁, FI₄ and FI₉) are illustrated in thick lines.

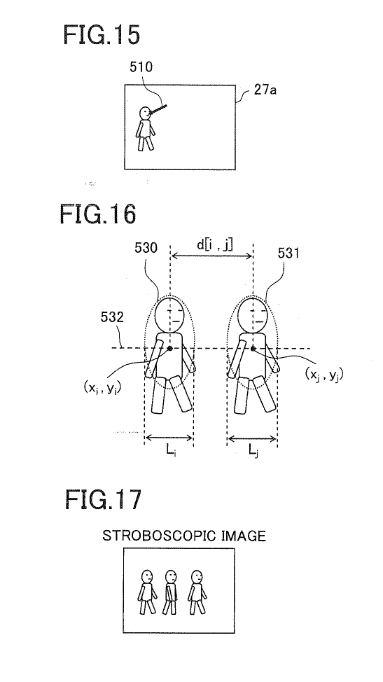

In the special reproduction mode, the first frame image FI₁ is displayed first on the display unit 27, and in this state of the display, a user's operation of setting the tracking target is received. For instance, as illustrated in FIG. 15, the frame image FI₁ is displayed, and an arrow type icon 510 is displayed on a display screen 27a of the display unit 27. The user can change the display position of the arrow type icon 510 by a predetermined operation to the operating unit 26. Then, using the operating unit 26, a predetermined determination operation is performed in the state where a display position of the arrow type icon 510 is set to a display position of the noted object (noted subject) on the display screen 27a, so that the user can set the noted object to the tracking target. As the example illustrated in FIG. 15, when the determination operation is performed in the state where a display position of the arrow type icon 510 is set to a display position of the person, the tracking process unit 61 can extract a contour of the object displayed at the display position of the arrow type icon 510 by utilizing a known contour extraction process and face detection process, so as to set the object as the tracking target from an extraction result and to set the image region in which image data of the object exists as the tracking target region on the frame image FI₁. Further, if the display unit 27 has a so-called touch panel function, it is possible to set the tracking target by an operation of touching the noted object with a finger on the display screen 27a.

The tracking process unit 61 derives a position and size of the tracking target region on each frame image based on image data of the frame images FI₁ to FI₁₀. Center positions of the tracking target regions on the frame images FIᵢ and FIⱼ are denoted by (xᵢ,yᵢ) and (xⱼ,yⱼ), respectively (i and j denote integers, and i is not equal to j). In addition, as illustrated in FIG. 16, a distance between the center position (xᵢ,yᵢ) and the center position (xⱼ,yⱼ) on the image space is denoted by d[i,j], and is also referred to as a distance between tracking targets. In FIG. 16, regions enclosed by broken lines 530 and 531 indicate tracking target regions on the frame images FIᵢ and FIⱼ, respectively. A distance between two intersection points of the contour of the tracking target region 530 and a straight line 532 connecting the center positions (xᵢ,yᵢ) and (xⱼ,yⱼ) is determined as a specific direction size Lᵢ, and a distance between two intersection points of the straight line 532 and the contour of the tracking target region 531 is determined as a specific direction size Lⱼ. The distance d[i,j] and the specific direction sizes Lᵢ and Lⱼ are determined by the image selection unit 62 based on the tracking result information of the frame images FIᵢ and FIⱼ.

The image selection unit 62 first extracts the first frame image FI₁ as a first selected image. Frame images that are taken after the frame image FI₁ as the first selected image are candidates of a second selected image. In order to extract the second selected image, the image selection unit 62 substitutes integers in the range from 2 to 10 for the variable j one by one so as to compare the distance between tracking targets d[1,j] with the target subject interval β. Then, among one or more frame images satisfying the inequality d[1,j]>β, a frame image FIⱼ that is taken after the first selected image and at a time closest to the first selected image is selected as the second selected image. Here, it is supposed that the inequality d[1,j]>β is not satisfied whenever j is two or three, while the inequality d[1,j]>β is satisfied whenever j is an integer in the range from four to ten. Then, the frame image FI₄ is extracted as the second selected image.

The target subject interval β means a target value of the distance between center positions of the tracking target regions on temporally neighboring two selected images. Specifically, for example, a target value of the distance between center positions of the tracking target regions on i-th and (i+1)th selected images is the target subject interval β. The image selection unit 62 can determine the target subject interval β to be said as a reference distance in accordance with the subject size SIZE′. As the subject size SIZE′ in the case where it is decided whether or not the inequality d[i,j]>β is satisfied, an average value of the specific direction sizes Lᵢ and Lⱼ can be used. However, it is possible to determine the subject size SIZE′ on the basis of three or more specific direction sizes. Specifically, for example, an average value of the specific direction sizes L₁ to L₁₀ may be substituted for the subject size SIZE′.

The image selection unit 62 determines the target subject interval β from the subject size SIZE′ so that β=SIZE′ is satisfied, or β=k₀×SIZE′ is satisfied, or β=SIZE′+k₁ is satisfied. Symbols k₀ and k₁ are predetermined coefficients. However, it is possible to determine the target subject interval β in accordance with a user's instruction. In addition, value of the coefficients k₀ and k₁ may be determined by the user.

In this way, the extraction process of selected images is performed so that the a distance between tracking targets (in this example, d[1,4]) on the first and the second selected images based on the detection result of position of the tracking target by the tracking process unit 61 is larger than the target subject interval β to be said as a reference distance (e.g., average value of L₁ and L₄) based on the detection result of size of the tracking target by the tracking process unit 61. The same is true for a third and later selected images to be extracted.

Specifically, frame images taken after the frame image FI₄ as the second selected image are candidates for the third selected image. In order to extract the third selected image, the image selection unit 62 substitutes integers in the range from five to ten for the variable j one by one so as to compare the distance between tracking targets d[4,j] with the target subject interval β. Then, among one or more frame images satisfying the inequality d[4,j]>β, a frame image FIⱼ that is taken after the second selected image and at a time closest to the second selected image is selected as the third selected image. Here, it is supposed that the inequality d[4,j]>β is not satisfied whenever j is within the range from 5 to 8, while the inequality d[4,j]>β is satisfied whenever j is nine or ten. Then, the frame image FI₉ is extracted as the third selected image.

Frame images taken after the frame image FI₉ as the third selected image are candidates for the fourth selected image. In this example, only the frame image FI₁₀ is a candidate for the fourth selected image. In order to extract the fourth selected image, the image selection unit 62 substitutes 10 for the variable j so as to compare the distance between tracking targets d[9,j] and the target subject interval β. Then, if the inequality d[9,j]>β is satisfied, the frame image FI₁₀ is extracted as the fourth selected image. On the other hand, if the inequality d[9,j]>β is not satisfied, the extraction process of selected images is completed without extracting the frame image FI₁₀ as the fourth selected image. Here, it is supported that the inequality d[9,j]>β is not satisfied when the variable j is 10. Then, eventually, three selected images including frame images FI₁, FI₄ and FI₉ are extracted. FIG. 17 illustrates the stroboscopic image generated from the three selected images.

<<Operational Flow>>

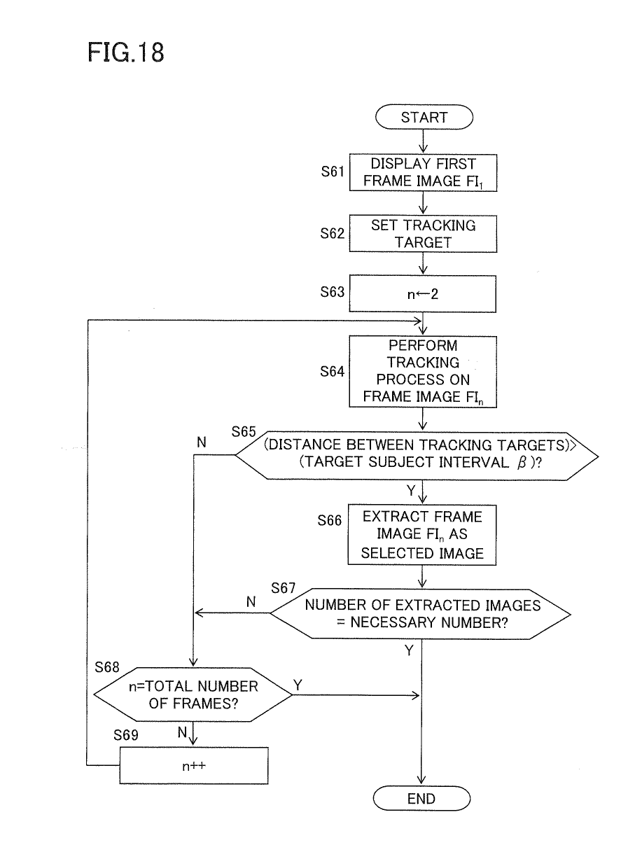

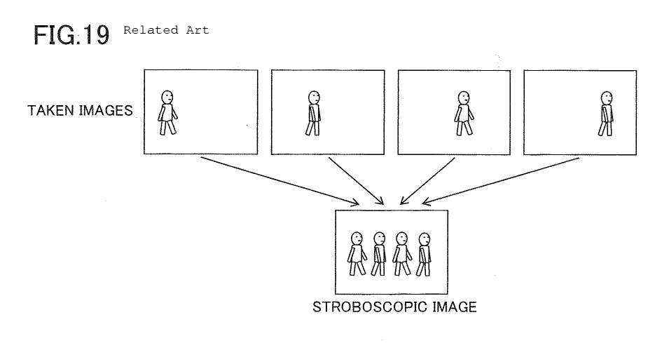

Next, with reference to FIG. 18, an operational flow of the image sensing apparatus 1 in the special reproduction mode will be described. FIG. 18 is a flowchart illustrating the operational flow. First, in Steps S61 and S62, the first frame image FI₁ is read out from the external memory 18 and is displayed on the display unit 27, and in this state, a user's setting operation of the tracking target is received. As described above, the first frame image FI₁ can be extracted as the first selected image. When the tracking target is set, two is substituted for the variable n in Step S63, and then in Step S64, the tracking process is performed on the frame image FIₙ, so that a position and size of the tracking target region on the frame image FIₙ is detected.

In the next Step S65, on the basis of the tracking result information from the tracking process unit 61, the above-mentioned comparison between the distance between tracking targets (corresponding to d[i,j]) and the target subject interval β is performed. Then, if the former is larger than the latter (β) the frame image FIₙ is extracted as the selected image in Step S66. Otherwise, the process goes directly to Step S68. In Step S67 following the Step S66, it is checked whether or not the number of extraction of the selected images is the same as a predetermined necessary number. If the numbers are identical, the extraction of selected images is finished at that time point. On the contrary, if the numbers are not identical, the process goes from Step S67 to Step S68. The user can specify the necessary number described above.

In Step S68, the variable n is compared with a total number of frame images forming the frame image sequence (ten in the example illustrated in FIG. 14). Then, if the current variable n is identical to the total number, the extraction of selected images is finished. Otherwise, one is added to the variable n (Step S69), and the process goes back to Step S64 so as to repeat the above-mentioned processes.

According to this embodiment, it is possible to realize extraction of the selected image sequence and generation of the stroboscopic image, in which the tracking targets are arranged at a desired position interval. Specifically, it is possible to adjust the position interval between tracking targets at different time points to a desired one. As a result, for example, overlapping of images of tracking targets at different time points on the stroboscopic image can be avoided (see FIG. 20). In addition, it is possible to avoid the situation where a selected image sequence having a small positional change of the tracking target is extracted.

Further in this embodiment, unlike the method described in JPA-2008-147721, the extraction of selected images is performed by using the tracking process. Therefore, a so-called background image in which no tracking target exists is not necessary, and extraction of a desired selected image sequence and generation of the stroboscopic image can be performed even if the background image does not exist. In addition, it is possible to set the target subject interval β to be smaller than the subject size SIZE′ in accordance with a user's request. In this case, it is possible to generate a stroboscopic image on which the images of the tracking targets at different time points are overlapped a little for each (such generation of the stroboscopic image cannot be performed by the method described in JP-A-2008-147721)

Further, although the stroboscopic image is generated from the plurality of selected images in this embodiment, generation of the stroboscopic image is not essential. The plurality of selected images have a function as so-called frame advance images (top forwarding images) noting the tracking target. Also in the case where the plurality of selected images are noted, the action and the effect of adjusting the position interval between tracking targets at different time points to a desired one is realized.

### Third Embodiment

A third embodiment of the present invention will be described. The plurality of taken images (images 311 to 314 in the example illustrated in FIG. 3) in which the noted specific subject is arranged at a desired position interval may be a frame image sequence in a moving image. A method of generating a stroboscopic image from a frame image sequence forming a moving image will be described in a third embodiment. The third embodiment is an embodiment based on the first embodiment, and the description in the first embodiment can be applied also to this embodiment concerning matters that are not described in particular in the third embodiment, as long as no contradiction arises. The following description in the third embodiment is a description of a structure of the image sensing apparatus 1 working effectively in the photography mode and an operation of the image sensing apparatus 1 in the photography mode, unless otherwise stated.

It is supposed that the moving image obtained by photography using the imaging unit 11 includes images I₁, I₂, I₃, . . . Iₙ₊₁, Iₙ₊₂, and so on (n denotes an integer). In the first embodiment, the images Iₙ to Iₙ₊ₚ₋₁ are regarded as the target images, and the image Iₙ₋₁ and images taken before the same are regarded as preview images (see FIG. 4), but in this embodiment they are all regarded as frame images forming the moving image 600. The frame image Iᵢ₊₁ is a frame image taken next after the frame image Iᵢ (i denotes an integer).

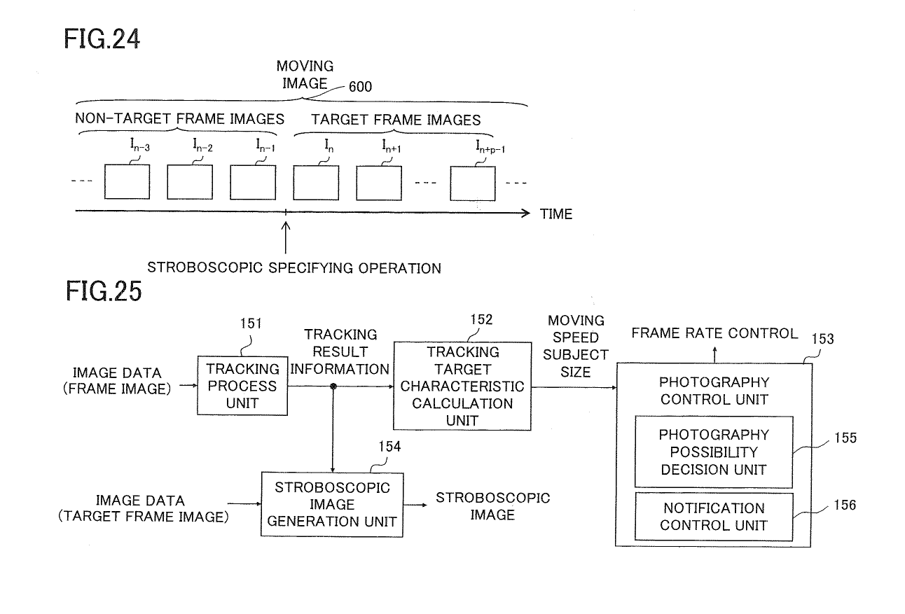

FIG. 24 illustrates a part of the frame image sequence forming the moving image 600. The moving image 600 may be one that is taken by the operation of pressing the record button 26a (see FIG. 1), and may be a moving image to be recorded in the external memory 18. The user can perform the stroboscopic specifying operation during photography of the moving image 600. The stroboscopic specifying operation is, for example, a predetermined operation to the operating unit 26 illustrated in FIG. 1 or a predetermined touch panel operation. When the stroboscopic specifying operation is performed, a part of the frame image sequence forming the moving image 600 is set as the target frame image sequence, and the stroboscopic image as described above in the first embodiment is generated from the target frame image sequence. Here, it is supposed that the stroboscopic specifying operation is performed right before the frame image is taken, and as a result, the frame images Iₙ to Iₙ₊ₚ₋₁ are set to a plurality of target frame images forming the target frame image sequence. Symbol p denotes the number of the target frame images. As described above in the first embodiment, p denotes an integer of two or larger. A value of p may be a preset fixed value or may be a value that the user can set freely. Note that the frame image taken before the target frame image (i.e., for example, the frame image Iₙ₋₁ or the like) is also referred to as a non-target frame image.

FIG. 25 is a block diagram of a portion included in the image sensing apparatus 1. Individual portions illustrated in FIG. 25 are realized by the CPU 23 or the video signal processing unit 13 illustrated in FIG. 1. For instance, a tracking process unit (object detection unit) 151 and a stroboscopic image generation unit (image combination unit) 154 may be mounted in the video signal processing unit 13, and a tracking target characteristic calculation unit (object characteristic deriving unit) 152 and a photography control unit 153 can be disposed in the CPU 23.

The tracking process unit 151, the tracking target characteristic calculation unit 152, the photography control unit 153 and the stroboscopic image generation unit 154 illustrated in FIG. 25 can realize the functions of the tracking process unit 51, the tracking target characteristic calculation unit 52, the sequential photography control unit 53 and the stroboscopic image generation unit 54 in the first embodiment, respectively (see FIG. 5). When the descriptions about the functions in the first embodiment are applied to this embodiment, the input moving image, the preview image, the target image and the sequential photography interval in the first embodiment should be read as the moving image 600, the non-target frame image, the target frame image and the photography interval in this embodiment, respectively.

Specifically, the tracking process unit 151 performs the tracking process for tracking on the moving image 600 the tracking target on the moving image 600 on the basis of image data of the moving image 600, so as to output the tracking result information including information indicating a position and size of the tracking target in each frame image.

The tracking target characteristic calculation unit 152 calculates, on the basis of the tracking result information of the tracking process performed on the non-target frame image sequence, moving speed SP of the tracking target on the image space and a subject size (object size) SIZE in accordance with the size of the tracking target on the image space. The moving speed SP functions as an estimated value of the moving speed of the tracking target on the target frame image sequence, and the subject size SIZE functions as an estimated value of the size of the tracking target on each target frame image. The moving speed SP and the subject size SIZE can be calculated on the basis of positions and sizes of the tracking target regions of two or more non-target frame images. This calculation method is the same as the method described above in the first embodiment, i.e., the method of calculating the moving speed SP and the subject size SIZE on the basis of positions and sizes of the tracking target regions of two or more preview images. For instance, when the two non-target frame images are denoted by I_{A} and I_{B}, the moving speed SP and the subject size SIZE can be calculated from the positions and sizes of the tracking target regions on the non-target frame images I_{A} and I_{B} (see FIG. 7), and the non-target frame images I_{A} and I_{B} are, for example, the non-target frame images Iₙ₋₂ and Iₙ₋₁, respectively.

The photography control unit 153 determines a value of INT_{TGT} in accordance with the equation (2) as described above in the first embodiment on the basis of the moving speed SP calculated by the tracking target characteristic calculation unit 152. In this case, as described above in the first embodiment, the target subject interval α in the equation (2) can be determined on the basis of the subject size SIZE calculated by the tracking target characteristic calculation unit 152 or on the basis of a user's instruction. In the first embodiment, the physical quantity represented by INT_{TGT} is referred to as the sequential photography interval, but in this embodiment the physical quantity represented by INT_{TGT} is referred to as the photography interval. The photography interval INT_{TGT} means an interval between photography time points of temporally neighboring two target frame images (e.g., Iₙ and Iₙ₊₁). The photography time point of the target frame image Iₙ means, in a strict sense, for example, a start time or a mid time of exposure period of the target frame image Iₙ (the same is true for any other frame images).

The photography control unit 153 sets the photography interval INT_{TGT} and then controls the imaging unit 11 together with the TG 22 (see FIG. 1) so that p target frame images are sequentially taken at the photography interval INT_{TGT}, i.e., the p target frame images are taken at a frame rate (1/INT_{TGT}). Thus, the p target frame images in which the tracking targets are arranged at substantially a constant position interval are obtained. As illustrated in FIG. 25, it is possible to dispose a photography possibility decision unit 155 and a notification control unit 156 in the photography control unit 153, so that the photography possibility decision unit 155 and the notification control unit 156 have similar functions as the sequential photography possibility decision unit 55 and the notification control unit 56 illustrated in FIG. 5.

The stroboscopic image generation unit 154 generates a stroboscopic image by combining images in the tracking target regions of the target frame images Iₙ to Iₙ₊ₚ₋₁ on the basis of the tracking result information for the target frame images Iₙ to Iₙ₊ₚ₋₁ and image data of the target frame images Iₙ to Iₙ₊ₚ₋₁. The generated stroboscopic image can be recorded in the external memory 18. The generation method of the stroboscopic image on the basis of the images Iₙ to Iₙ₊ₚ₋₁ is as described above in the first embodiment. Note that any stroboscopic image described above is a still image. To distinguish the stroboscopic image as a still image from the stroboscopic image of a moving image format described below, the stroboscopic image as a still image is also referred to as a stroboscopic still image, if necessary in the following description.

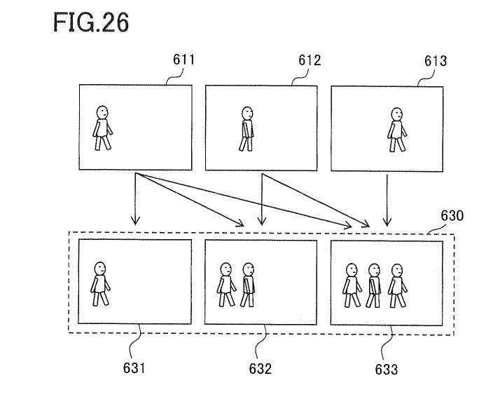

The stroboscopic image generation unit 154 can also generate a stroboscopic moving image. It is supposed that p is three, and the target frame images Iₙ to Iₙ₊₂ are respectively images 611 to 613 illustrated in FIG. 26, so that a stroboscopic moving image 630 based on them will be described. The stroboscopic moving image 630 is a moving image including three frame images 631 to 633. The frame image 631 is the same as the image 611. The frame image 632 is a stroboscopic still image obtained by combining the images in the tracking target regions on the images 611 and 612 on the basis of the tracking result information for the images 611 and 612 and the image data of the images 611 and 612. The frame image 633 is a stroboscopic still image obtained by combining the images in the tracking target regions on the images 611 to 613 on the basis of the tracking result information for the images 611 to 613 and the image data of the images 611 to 613. By arranging the frame images 631 to 633 obtained in this way in this order in the time sequence, the stroboscopic moving image 630 is formed. The generated stroboscopic moving image 630 can be recorded in the external memory 18.

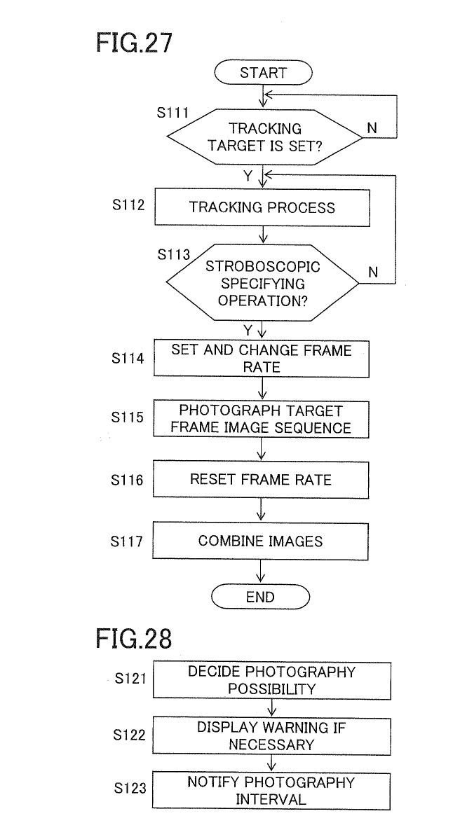

With reference to FIG. 27, an operational flow of the image sensing apparatus 1 according to the third embodiment will be described. FIG. 27 is a flowchart illustrating the operational flow. First, in Step S111, it is waited that the tracking target is set. When the tracking target is set, the process goes from Step S111 to Step S112, in which the tracking process is started for the tracking target. After the tracking target is set, the tracking process is performed continuously in other steps than Step S112. For convenience sake of description, it is supposed that the entire tracking target region (i.e., the entire image of the tracking target) is included in each frame image after the tracking target is set. Note that recording of the moving image 600 in the external memory 18 may be started before the tracking target is set or after the tracking target is set.

After starting the tracking process, it is checked in Step S113 whether or not the stroboscopic specifying operation is performed. When it is checked that the stroboscopic specifying operation is performed, the moving speed SP and the subject size SIZE are calculated on the basis of the latest tracking result information obtained at that time point (tracking result information of two or more non-target frame images). Further, the photography interval INT_{TGT} is set by using the moving speed SP and the subject size SIZE, so that the target frame image sequence is photographed (Steps S114 and S115). Specifically, the frame rate (1/INT_{TGT}) for the target frame image sequence is set, and in accordance with the set contents, the frame rate of the imaging unit 11 is actually changed from a reference rate to (1/INT_{TGT}). Then, the target frame images Iₙ to Iₙ₊ₚ₋₁ are photographed. The reference rate is a frame rate for non-target frame images.

When the photography of the target frame images Iₙ to Iₙ₊ₚ₋₁ is completed, the frame rate is reset to the reference rate (Step S116). After that, the stroboscopic still image (e.g., stroboscopic still image 633 illustrated in FIG. 26) or the stroboscopic moving image (e.g., stroboscopic moving image 630 illustrated in FIG. 26) is generated from the target frame image sequence at an arbitrary timing.

When the stroboscopic specifying operation is performed, the photography possibility decision unit 155 may perform the photography possibility decision of the target frame image and/or the notification control unit 156 may perform the photography interval notification before (or during) the photography of the target frame image sequence. Specifically, for example, when the stroboscopic specifying operation is performed, the process in Steps S121 to S123 illustrated in FIG. 28 may be performed. In Step S121, the photography possibility decision unit 155 decides whether or not the p target frame images can be photographed. This decision method is similar to the decision method of possibility of the sequential photography of p target images performed by the sequential photography possibility decision unit 55 illustrated in FIG. 5. In the situation where the sequential photography possibility decision unit 55 decides that the sequential photography of p target images can be performed, the photography possibility decision unit 155 decides that the p target frame images can be photographed. In the situation where the sequential photography possibility decision unit 55 decides that the sequential photography of p target images cannot be performed, the photography possibility decision unit 155 decides that the p target frame images cannot be photographed. If the photography possibility decision unit 155 decides that the p target frame images cannot be photographed, the notification control unit 156 notified the fact to the user by sound or video output in Step S122. In addition, in Step S123, the notification control unit 156 notifies information corresponding to the photography interval INT_{TGT} to the outside of the image sensing apparatus 1. The notification method is the same as that described above in the first embodiment.

According to this embodiment, the frame rate is optimized so that the tracking targets are arranged at a desired position interval in accordance with the moving speed of the tracking target. Specifically, the position interval of the tracking targets at the different time points is optimized, so that overlapping of tracking targets at different time points on the stroboscopic image can be avoided, for example (see FIG. 20). In addition, it is also possible to avoid a situation where the tracking target is not included in a target frame image that is taken at later timing (e.g., target frame image Iₙ₊ₚ₋₁) (see FIG. 21), or a situation where a target frame image sequence with a small positional change of the tracking target is taken (see FIG. 20).

There are many common features between the first and the third embodiments. In the first embodiment, the target image sequence including p target images is obtained by the sequential photography. In contrast, in the third embodiment, the target frame image sequence including p target frame images is obtained by photography of the moving image 600. The sequential photography control unit 53 in the first embodiment or the photography control unit 153 in the third embodiment (see FIG. 5 or 25) functions as the photography control unit that controls the imaging unit 11 to obtain p target images or p target frame images. The sequential photography interval INT_{TGT} in the first embodiment is an interval between photography time points of two temporally neighboring target images (e.g., Iₙ and Iₙ₊₁), and so the sequential photography interval in the first embodiment can be referred to as the photography interval similarly to the third embodiment. In addition, the preview image in the first embodiment can be referred to as the non-target image. In addition, the sequential photography possibility of the target image sequence and the photography possibility of the target image sequence have the same meaning. Therefore, the sequential photography possibility decision unit 55 illustrated in FIG. 5 can also be referred to as a photography possibility decision unit that decides photography possibility of the target image sequence.

Note that the generation of the stroboscopic image is not essential (the same is true in other embodiments described later). The plurality of target frame images (or a plurality of select images described later) have a function as so-called frame advance images (top forwarding images) noting the tracking target. Also in the case where a plurality of target frame images (or a plurality of select images described later) are noted, the action and the effect of adjusting the position interval between tracking targets at different time points to a desired one is realized.

In addition, it is possible to set a time length of exposure period of each target frame image (hereinafter referred to as exposure time) on the basis of the moving speed SP calculated by the tracking target characteristic calculation unit 152. Specifically, for example, it is preferred to set the exposure time of each target frame image so that the exposure time of each target frame image decreases along with an increase of the moving speed SP. Thus, it is possible to suppress image blur of the tracking target on each target frame image. This setting operation of the exposure time can be applied also to the first embodiment described above. Specifically, in the first embodiment, it is preferred to set the exposure time of each target image so that the exposure time of each target image decreases along with an increase of the moving speed SP on the basis of the moving speed SP calculated by the tracking target characteristic calculation unit 52.

### Fourth Embodiment

A fourth embodiment of the present invention will be described. Another method of generating a stroboscopic image from a frame image sequence forming a moving image will be described in a fourth embodiment. The fourth embodiment is an embodiment based on the first and the third embodiment, and the description in the first or the third embodiment can be applied also to this embodiment concerning matters that are not described in particular in the fourth embodiment, as long as no contradiction arises. The following description in the fourth embodiment is a description of a structure of the image sensing apparatus 1 working effectively in the photography mode and an operation of the image sensing apparatus 1 in the photography mode, unless otherwise stated.

Also in the fourth embodiment, it is supposed that the moving image 600 including the frame images I₁, I₂, I₃, . . . Iₙ, Iₙ₊₁, Iₙ₊₂, and so on is obtained by photography similarly to the third embodiment.

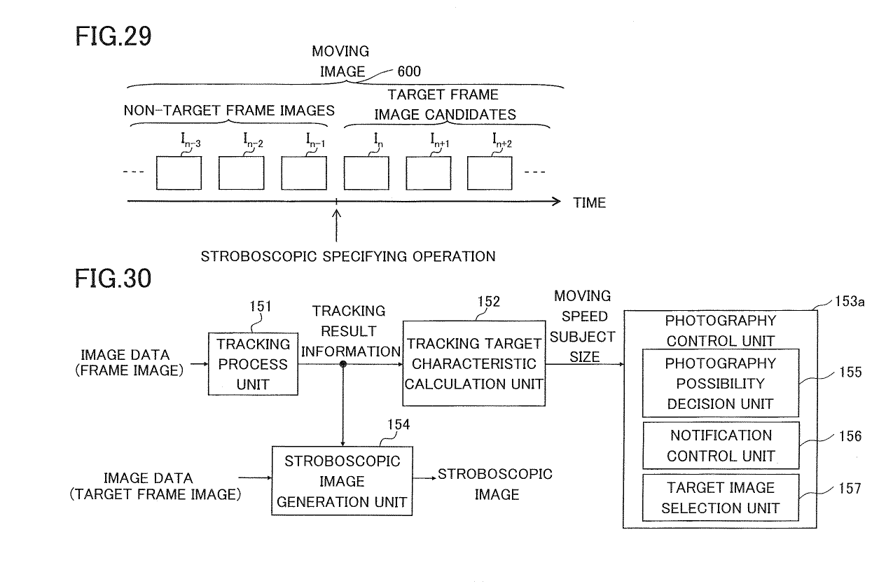

FIG. 29 illustrates a part of the frame image sequence foaming the moving image 600. The user can perform the stroboscopic specifying operation during the photography of the moving image 600. Unlike the third embodiment, in the fourth embodiment, when the stroboscopic specifying operation is performed, a part of the frame images forming the moving image 600 is set to the target frame image candidates. After that, a plurality of target frame images are selected from a plurality of target frame image candidates. Then, on the basis of the plurality of target frame images, the stroboscopic still image as described above in the first or the third embodiment or the stroboscopic moving image as described above in the third embodiment is generated. Here, it is supposed that the stroboscopic specifying operation is performed right before the photography of the frame image Iₙ, and as a result, each of the frame image Iₙ and frame images obtained after that is set to the target frame image candidate. Note that the frame images photographed before the target frame image candidate (i.e., for example, the frame image Iₙ₋₁ and the like) are particularly referred to as non-target frame images, too.

FIG. 30 is a block diagram of a portion included in the image sensing apparatus 1. A photography control unit 153a illustrated in FIG. 30 can be realized by the CPU 23 illustrated in FIG. 1. The photography control unit 153a corresponds to the photography control unit 153 illustrated in FIG. 25 to which a target image selection unit 157 is added. However, the photography control unit 153a does not perform the frame rate control as that performed by the photography control unit 153.

The tracking process unit 151, the tracking target characteristic calculation unit 152, the photography control unit 153a and the stroboscopic image generation unit 154 in FIG. 30 can realize functions of the tracking process unit 51, the tracking target characteristic calculation unit 52, the sequential photography control unit 53 and the stroboscopic image generation unit 54 in the first embodiment, respectively (see FIG. 5). When descriptions in the first embodiment are applied to this embodiment concerning the functions, the input moving image, the preview image, the target image and the sequential photography interval in the first embodiment should be read as the moving image 600, the non-target frame image, the target frame image and the photography interval, respectively, in this embodiment. Operations of the tracking process unit 151, the tracking target characteristic calculation unit 152 and the stroboscopic image generation unit 154 are the same between the third and the fourth embodiments.

The target image selection unit 157 determines a value of INT_{TGT} in accordance with the equation (2) described above in the first embodiment on the basis of the moving speed SP calculated by the tracking target characteristic calculation unit 152. In this case, as described above in the first embodiment, the target subject interval α in the equation (2) can be determined on the basis of the subject size SIZE calculated by the tracking target characteristic calculation unit 152 or on the basis of a user's instruction. In the first embodiment, the physical quantity represented by INT_{TGT} is referred to as the sequential photography interval, but in this embodiment the physical quantity represented by INT_{TGT} is referred to as a reference interval. The reference interval INT_{TGT} means an ideal interval between photography time points of temporally neighboring two target frame images (e.g., Iₙ and Iₙ₊₃).

Unlike the third embodiment, in the fourth embodiment, the frame rate in the photography of the moving image 600 is fixed to a constant rate. The target image selection unit 157 selects the p target frame images from the target frame image candidates on the basis of the reference interval INT_{TGT}. After this selection, the stroboscopic image generation unit 154 can generate the stroboscopic still image or the stroboscopic moving image on the basis of the p target frame images and the tracking result information at any timing in accordance with the method described above in the third embodiment.

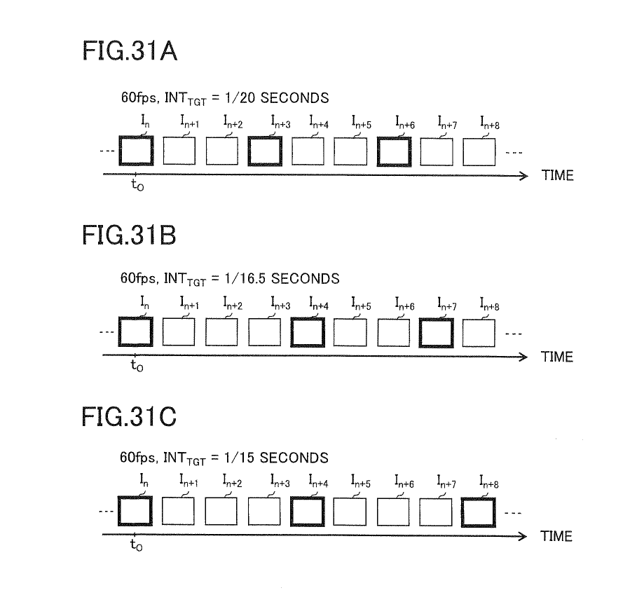

For specific description, it is supposed that the frame rate in the photography of the moving image 600 is fixed to 60 frames per second (fps) and that p is three, and the select method of the target frame images will be described. In this case, the photography interval between temporally neighboring frame images is 1/60 seconds. As illustrated in FIG. 31A, the photography time point of the frame image Iₙ is denoted by t_{O}, and the photography time point of the frame image Iₙ₊ᵢ is expressed by (t_{O}+i× 1/60). The time (t_{O}+i× 1/60) means time after time t_{O} by a lapse of (i× 1/60) seconds. In FIG. 31A, outer frames of frame images Iₙ, Iₙ₊₃ and Iₙ₊₆ that are to be selected as the target frame images are illustrated by thick lines (the same is true in the FIGS. 31B and 31C that will be referred to later).

First, the target image selection unit 157 selects the frame image Iₙ that is a first target frame image candidate as the first target frame image regardless of the reference interval INT_{TGT}. Next, the target image selection unit 157 sets the target frame image candidate whose photography time point is closest to the time (t_{O}+1×INT_{TGT}) as a second target frame image among all target frame image candidates. Next, the target image selection unit 157 sets the target frame image candidate whose photography time point is closest to the time (t_{O}+2×INT_{TGT}) as a third target frame image among all target frame image candidates. The same is true for the cases where p is four or larger. In generalization, the target image selection unit 157 sets the target frame image candidate whose photography time point is closest to the time (t_{O}+(j−1)×INT_{TGT}) as a j-th target frame image among all target frame image candidates (here, j denotes an integer of two or larger).

Therefore, for example, in the case where the frame rate of the moving image 600 is 60 fps, if the reference interval INT_{TGT} is 1/20 seconds, the images Iₙ₊₃ and Iₙ₊₆ are selected as the second and the third target frame images (see FIG. 31A). If the reference interval INT_{TGT} is 1/16.5 seconds, the images Iₙ₊₄ and Iₙ₊₇ are selected as the second and the third target frame images (see FIG. 31B). If the reference interval INT_{TGT} is 1/15 seconds, the images Iₙ₊₄ and Iₙ₊₈ are selected as the second and the third target frame images (see FIG. 31C). However, if the reference interval INT_{TGT} is 1/16.5 seconds, the images Iₙ₊₄ and Iₙ₊₈ may be selected as the second and the third target frame images so that the photography interval between the temporally neighboring target frame images becomes constant.

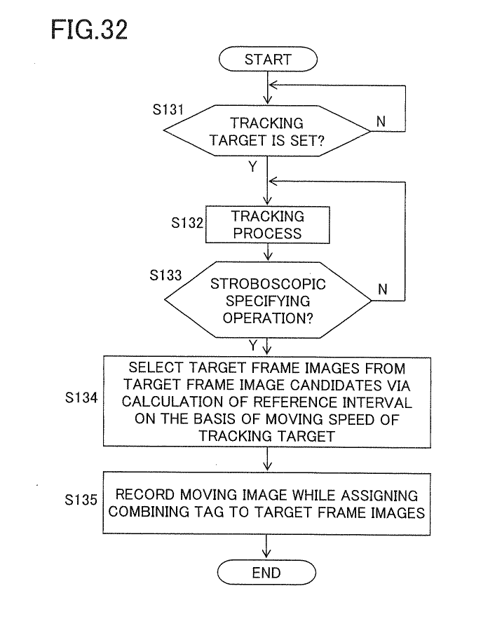

With reference to FIG. 32, an operation flow of the image sensing apparatus 1 according to the fourth embodiment will be described. FIG. 32 is a flowchart illustrating the operational flow. First, in Step S131, it is waited that the tracking target is set. When the tracking target is set, the process goes from Step S131 to Step S132, in which the tracking process is started for the tracking target. After the tracking target is set, the tracking process is performed continuously in other steps than Step S132. For convenience sake of description, it is supposed that the entire tracking target region (i.e., the entire image of the tracking target) is included in each frame image after the tracking target is set. Note that recording of the moving image 600 in the external memory 18 may be started before the tracking target is set or after the tracking target is set. However, it is supposed that the recording of the moving image 600 in the external memory 18 is started at least before the first target frame image candidate is photographed.

After starting the tracking process, it is checked in Step S133 whether or not the stroboscopic specifying operation is performed. When it is checked that the stroboscopic specifying operation is performed, the moving speed SP and the subject size SIZE are calculated on the basis of the latest tracking result information obtained at that time point (tracking result information of two or more non-target frame images) in Step S134. Then, the reference interval INT_{TGT} is calculated by using the moving speed SP and the subject size SIZE. The target image selection unit 157 selects the p target frame images from the target frame image candidates by using the reference interval INT_{TGT} as described above.

The image data of the frame images forming the moving image 600 are recorded in the external memory 18 in time sequence order. In this case, combining tag is assigned to the target frame image (Step S135). Specifically, for example, a header region of the image file for storing image data of the moving image 600 should store the combining tag indicating which frame image the target frame image is. When the image file is stored in the external memory 18, the image data of the moving image 600 and the combining tag are associated with each other and are recorded in the external memory 18.

After the moving image 600 is recorded, at any timing, the stroboscopic image generation unit 154 can read the p target frame images from the external memory 18 on the basis of the combining tag recorded in the external memory 18. From the read p target frame images, the stroboscopic still image (e.g., the stroboscopic still image 633 illustrated in FIG. 26) or the stroboscopic moving image (e.g., the stroboscopic moving image 630 illustrated in FIG. 26) can be generated.

Further, when the stroboscopic specifying operation is performed, similarly to the third embodiment, it is possible to perform photography possibility decision of the target frame image by the photography possibility decision unit 155 and/or the photography interval notification by the notification control unit 156 before (or during) the photography of the target frame image candidates.

According to this embodiment, the target frame images are selected so that the tracking targets are arranged at a desired position interval. Specifically, the position interval between tracking targets at different time points is optimized on the target frame image sequence. As a result, for example, overlapping of tracking targets at different time points on the stroboscopic image can be avoided (see FIG. 20). In addition, it is also possible to avoid a situation where the tracking target is not included in a target image that is taken at later timing (see FIG. 21), or a situation where a target frame image sequence with a small positional change of the tracking target is taken (see FIG. 20).

Further, as described above in the third embodiment, it is possible to set exposure time of each target frame image candidate on the basis of the moving speed SP calculated by the tracking target characteristic calculation unit 152. Specifically, for example, it is preferred to set the exposure time of each target frame image candidate so that the exposure time of each target frame image candidate decreases along with an increase of the moving speed SP. Thus, it is possible to suppress image blur of the tracking target on each target frame image candidate and each target frame image.

### Fifth Embodiment

A fifth embodiment of the present invention will be described. The fifth embodiment is an embodiment based on the second embodiment. Concerning matters that are not described in fifth embodiment in particular, the description in the second embodiment can also be applied to this embodiment as long as no contradiction arises. Also in the fifth embodiment, similarly to the second embodiment, the operation of the image sensing apparatus 1 in the special reproduction mode will be described. In the special reproduction mode, the tracking process unit 61, the image selection unit 62 and the stroboscopic image generation unit 63 illustrated in FIG. 13 work significantly.

As described above in the second embodiment, the image sequence obtained by the sequential photography performed by the imaging unit 11 at a predetermined frame rate is stored as the frame image sequence on the external memory 18, and in the special reproduction mode, the image data of the frame image sequence is read out from the external memory 18. The frame image in this embodiment is a frame image read out from the external memory 18 in the special reproduction mode unless otherwise stated.

The tracking process unit 61 performs the tracking process on each frame image after the tracking target is set, so as to generate the tracking result information including the information indicating position and size of the tracking target region on each frame image. The image selection unit 62 selects and extracts a plurality of frame images as a plurality of selected images from the frame image sequence on the basis of the tracking result information from the tracking process unit 61, and sends image data of each selected image to the stroboscopic image generation unit 63. The stroboscopic image generation unit 63 combines images in the tracking target region of each selected image on the basis of tracking result information for each selected image and image data of each selected image so as to generate the stroboscopic image. The generated stroboscopic image can be recorded in the external memory 18. The stroboscopic image to be generated may be a stroboscopic still image as the stroboscopic still image 633 illustrated in FIG. 26 or may be a stroboscopic moving image as the stroboscopic moving image 630 illustrated in FIG. 26. In the fifth embodiment, the number of the selected images is denoted by p (p is an integer of two or larger).

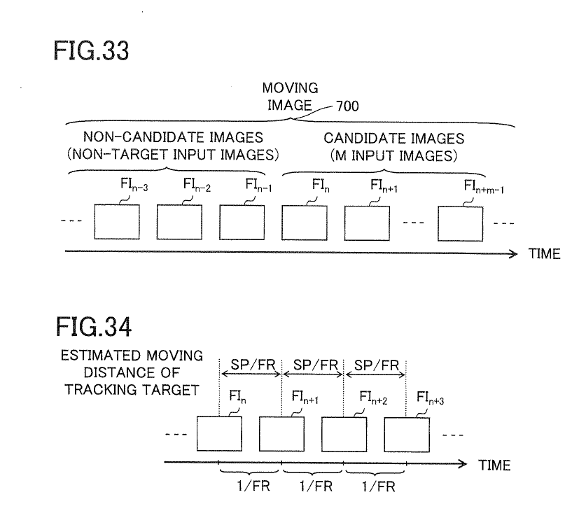

The moving image as the frame image sequence read from the external memory 18 is referred to as a moving image 700. FIG. 33 illustrates frame images forming the moving image 700. It is supposed that the moving image 700 includes frame images FI₁, FI₂, FI₃, . . . FIₙ₊₁, FIₙ₊₂, and so on. As described above in the second embodiment, the frame image FIᵢ₊₁ is an image taken next after the frame image FIᵢ (i denotes an integer). It is not necessary that image data of the tracking target exists in every frame image. However, for convenience sake of description, it is supposed that image data of the tracking target exists in every frame image forming the moving image 700. In addition, it is supposed that the frame rate FR of the moving image 700 is constant. When the frame rate of the moving image 700 is 60 fps, FR is 60. A unit of FR is inverse number of second.

The user can specify freely the frame image to be a candidate of the selected image from the frame images forming the moving image 700. Usually, temporally continuing plurality of frame images are set as candidates of the selected images. Here, it is supposed that m frame images FIₙ to FIₙ₊ₘ₋₁, are set as candidates of the selected images as illustrated in FIG. 33, and the frame images FIₙ to FIₙ₊ₘ₋₁ are also referred to as candidate images (m input images). In addition, a frame image (e.g., frame image FIₙ₋₁) obtained by photography before the frame image FIₙ is particularly also referred to as a non-candidate image (non-target input image). Symbol m denotes an integer of two or larger and satisfies m>p.

The image selection unit 62 can use the detection result of the moving speed SP of the tracking target so as to determine the selected images. The detection methods of the moving speed SP performed by the image selection unit 62 are roughly divided into a moving speed detection method based on the non-candidate image and a moving speed detection method based on the candidate image.

In the moving speed detection method based on the non-candidate image, the tracking result information for the non-candidate image is utilized, so that the moving speed SP of the tracking target on the candidate image sequence is estimated and detected on the basis of positions of the tracking target regions on the plurality of non-candidate images. For instance, two different non-candidate images are regarded as frame images FIᵢ and FIⱼ illustrated in FIG. 16, so that the moving speed SP is calculated from the distance between tracking targets d[i,j] determined for the frame images FIᵢ and FIⱼ and the frame rate FR of the moving image 700. A photography time difference between the frame images FIᵢ and FIⱼ (i.e., time difference between the photography time point of the frame image FIᵢ and the photography time point of the frame image FIⱼ) is derived from the frame rate FR of the moving image 700, and the distance between tracking targets d[i,j] is divided by the photography time difference so that the moving speed SP can be calculated. The frame images FIᵢ and FIⱼ as two non-candidate images may be the temporally neighboring frame images (e.g., frame images FIₙ₋₂ and FIₙ₋₁, or frame images FIₙ₋₃ and FIₙ₋₂), or may be temporally non-neighboring frame images (e.g., frame images FIₙ₋₃ and FIₙ₋₁, or frame images FIₙ₋₄ and FIₙ₋₁). For instance, when the non-candidate images FIₙ₋₂ and FIₙ₋₁ are used as the frame images FIᵢ and FIⱼ, the moving speed SP is calculated in accordance with SP=d[n−2,n−1]±1/FR. When the non-candidate images FIₙ₋₃ and FIₙ₋₁ are used as the frame images FIᵢ and FIⱼ, the moving speed SP is calculated in accordance with SP=d[n−3,n−1]±2/FR.

In the moving speed detection method based on the candidate image, the tracking result information for the candidate image is used, the moving speed SP of the tracking target on the candidate image sequence is detected on the basis of positions of the tracking target regions on the plurality of candidate images. For instance, two different candidate images are regarded as the frame images FIᵢ and FIⱼ illustrated in FIG. 16, so that the moving speed SP is calculated from a distance between tracking targets d[i,j] determined for the frame images FIᵢ and FIⱼ and the frame rate FR of the moving image 700. A photography time difference between the frame images FIᵢ and FIⱼ (i.e., time difference between the photography time point of the frame image FIᵢ and the photography time point of the frame image FIⱼ) is derived from the frame rate FR of the moving image 700, and the distance between tracking targets d[i,j] is divided by the photography time difference so that the moving speed SP can be calculated. The frame images FIᵢ and FIⱼ as two candidate images may be temporally neighboring frame images (e.g., the frame images FIₙ and FIₙ₊₁, or the frame images FIₙ₊₁ and FIₙ₊₂), or may be temporally non-neighboring frame images (e.g., the frame images FIₙ and FIₙ₊₂, or the frame images FIₙ and FIₙ₊ₘ₋₁). For instance, when the candidate images FIₙ and FIₙ₊₁ are used as the frame images FIᵢ and FIⱼ, the moving speed SP is calculated in accordance with SP=d[n,n+1]±1/FR. When the candidate images FIₙ and FIₙ₊₂ are used as the frame images FIᵢ and FIⱼ, the moving speed SP is calculated in accordance with SP=d[n,n+2]±2/FR.

On the other hand, the image selection unit 62 determines the target subject interval β described above in the second embodiment. The image selection unit 62 can determine the target subject interval β in accordance with the method described above in the second embodiment. Specifically, for example, the target subject interval β can be determined in accordance with the subject size SIZE′. As a calculation method of the subject size SIZE′, the method described above in the second embodiment can be used. Specifically, for example, an average value of the specific direction sizes Lᵢ and Lⱼ (more specifically, the specific direction sizes Lₙ and Lₙ₊₁, for example) may be determined as the subject size SIZE′. If a value of m is fixed before the subject size SIZE′ is derived, an average value of the specific direction sizes Lₙ to Lₙ₊ₘ₋₁ may be determined as the subject size SIZE′.

The image selection unit 62 first sets the frame image FIₙ that is the first candidate image to the first selected image. Then, based on the detected moving speed SP, a moving distance of the tracking target between different candidate images is estimated. Since the frame rate of the moving image 700 is FR, the estimated moving distance of the tracking target between the frame images FIₙ and FIₙ₊ᵢ is “i×SP/FR” as illustrated in FIG. 34. The estimated moving distance “i×SP/FR” based on the detection result of the position of the tracking target by the tracking process unit 61 corresponds to an estimated value of a distance between tracking targets on the frame images FIₙ and FIₙ₊ᵢ (i.e., a distance between the position of the tracking target on the frame image FIₙ and the position of the tracking target on the frame image FIₙ₊ᵢ).

The image selection unit 62 extracts the second selected image from the candidate image sequence so that the distance between tracking targets on the first and the second selected images based on the estimated moving distance is larger than the target subject distance β that is to be said as a reference distance based on the detection result of the size of the tracking target by the tracking process unit 61. The frame image photographed after the frame image FIₙ as the first selected image is to be a candidate of the second selected image. In order to extract the second selected image, the image selection unit 62 substitutes integers from (n+1) to (n+m−1) for the variable j one by one and compares the estimated moving distance “(j−n)×SP/FR” that is an estimated value of the distance between tracking targets d[n,j] with the target subject interval β. Then, among one or more candidate images satisfying the inequality (j−n)×SP/FR>β, the candidate image FIⱼ that is photographed after the first selected image and at a time point closest to the first selected image is selected as the second selected image. Here, it is supposed that the inequality is not satisfied whenever j is (n+1) or (n+2) while the inequality is satisfied whenever j is an integer of (n+3) or larger. Then, the candidate image FIₙ₊₃ is extracted as the second selected image.

Third and later selected images are also selected in the same manner. Specifically, the image selection unit 62 extracts the third selected image from the candidate image sequence so that a distance between tracking targets on the second and the third selected images based on the estimated moving distance is larger than the target subject distance (in this case, however, there is imposed the condition that a photography time difference between the second and the third selected images is set to be as small as possible).

Note that the third selected image may be automatically determined from the photography interval between the first and the second selected images. Specifically, the third selected image may be determined so that the photography interval between the second and the third selected images becomes the same as the photography interval between the first and the second selected images. In this case, for example, when the frame image FIₙ₊₃ is extracted as the second selected image, the third selected image is automatically determined as the frame image FIₙ₊₆. The same is true for the fourth and later selected images.

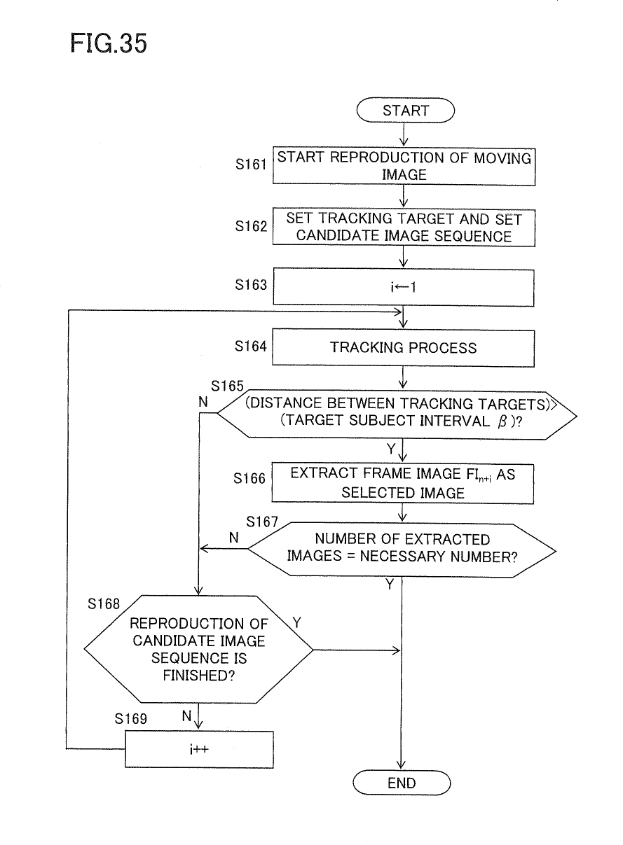

With reference to FIG. 35, an example of an operational flow of the image sensing apparatus 1 in the special reproduction mode will be described. FIG. 35 is a flowchart illustrating this operational flow. First, in Steps S161 and S162, reproduction of the moving image 700 is started while a menu inviting the user to setting operation of the tracking target and setting operation of the candidate image sequence is displayed on the display unit 27. In this state, user's setting operation of the tracking target and setting operation of the candidate image sequence is accepted. By the setting operation of the candidate image sequence, the user can set the frame image sequence in any video section in the moving image 700 to the candidate image sequence. As described above, the first frame image in the candidate image sequence can be extracted as the first selected image. When the tracking target and the candidate image sequence are set, one is substituted for the variable i in Step S163, and the tracking process is performed on the frame image FIₙ₊ᵢ in Step S164, so that the position and size of the tracking target region on the frame image FIₙ₊ᵢ can be detected. Further, when the moving speed SP is calculated by using the non-candidate image, the tracking process is performed also on the non-candidate image sequence.

In the next Step S165, based on the tracking result information from the tracking process unit 61, the estimated value of the distance between tracking targets is compared with the target subject interval β. Then, if the former is large than the latter (β), the frame image FIₙ₊ᵢ is extracted as the selected image in Step S166. Otherwise, the process goes directly to Step S168. In Step S167 following the Step S166, it is checked whether or not the number of extraction of selected images is the same as a predetermined necessary number (i.e., a value of p). If the numbers are identical, the extraction of selected images is finished at that time point. On the contrary, if the numbers are not identical, the process goes from Step S167 to Step S168. The user can specify the necessary number.

In Step S168, the variable i is compared with a total number of the candidate images (i.e., a value of m). Then, if the current variable i is identical to the total number, it is decided that the reproduction of the candidate image sequence is finished, and the extraction process of the selected images is finished. Otherwise, one is added to the variable i (Step S169) and the process goes back to Step S164, so that the above-mentioned processes are repeated.

In this embodiment too, the same effect as the second embodiment can be obtained.

### Sixth Embodiment

A sixth embodiment of the present invention will be described. In the sixth embodiment, compression and expansion of the image data are considered, and a method that can be applied to the second and the fifth embodiment will be described. For specific description, it is supposed that the moving image 700 illustrated in FIG. 33 is recorded in the external memory 18.

When the moving image 700 is recorded in the external memory 18, the image data of the moving image 700 is compressed by a predetermined compression method performed by the compression processing unit 16 illustrated in FIG. 1. Any compression method may be adopted. For instance, a compression method defined in Moving Picture Experts Group (MPEG) or a compression method defined in H.264 can be used. Hereinafter, image data that is compressed is particularly referred to as compressed image data, and image data that is not compressed is particularly referred to as non-compressed image data. When the moving image 700 is reproduced on the display unit 27, the compressed image data of the moving image 700 read out from the external memory 18 is sent to the expansion processing unit 19 illustrated in FIG. 1, and the expansion processing unit 19 performs an expansion process for restoring the compressed image data to non-compressed image data. The non-compressed image data of the moving image 700 obtained by this process is sent to the display processing unit 20, so that the moving image 700 is displayed as images on the display unit 27.

The non-compressed image data of the moving image 700 is a set of still images that are independent of each other. Therefore, the non-compressed image data that is the same as that transmitted to the display processing unit 20 is written in the internal memory 17 illustrated in FIG. 1 as necessary, so that the stroboscopic still image or the stroboscopic moving image can be generated from the non-compressed image data stored in the internal memory 17. Actually, after the setting operation of the candidate image sequence is performed by the user (see Step S162 illustrated in FIG. 35), the non-compressed image data that is the same as that transmitted to the display processing unit 20 during the reproduction section of the candidate image sequence should be written in the internal memory 17. In order to generate the stroboscopic image on the basis of the compressed image data, it is necessary to expand the compressed image data. As described above, the expansion process that is performed for reproducing images can be used for the above-mentioned expansion.

Further, in MPEG, an MPEG moving image that is a compression moving image is generated by utilizing a difference between frames. As known well, the MPEG moving image is constituted of three types of picture, including an I-picture that is an intra-coded picture, a P-picture that is a predictive-coded picture, and a B-picture that is a bidirectionally predictive-coded picture. Since the I-picture is an image obtained by coding an video signal of one frame image within the frame image, it is possible to decode the video signal of the one frame image by the single I-picture. In contrast, by a single P-picture, the video signal of one frame image cannot be decoded. In order to decode the frame image corresponding to the P-picture, it is necessary to perform a differential operation or the like with another picture. The same is true for the B-picture. Therefore, operational load necessary for decoding the frame image corresponding to the P-picture or the B-picture is larger than that corresponding to the I-picture.

Considering this, in order to reduce the operational load, it is possible to constitute the candidate image sequence in the fifth embodiment by using only I-pictures (similarly, it is possible to constitute the frame images FI₁ to FI₁₀ in the second embodiment by using only I-pictures). In this case, even if the frame rate of the moving image 700 is 60 fps, the frame rate of the candidate image sequence is approximately 3 to 10 fps, for example. However, there is little problem in the case where the moving speed of the tracking target is not so high.

<<Variations>>

Specific numerical values indicated in the above description are merely examples, and they can be changed to various values as a matter of course. As variations or annotations of the embodiments described above, Note 1 and Note 2 are described below. Descriptions in the Notes can be combined in any way as long as no contradiction arises.

[Note 1]

In the examples described above, the image processing apparatus including the tracking process unit 61, the image selection unit 62 and the stroboscopic image generation unit 63 illustrated in FIG. 13 is disposed in the image sensing apparatus 1. However, the image processing apparatus may be disposed outside the image sensing apparatus 1. In this case, the image data of the frame image sequence obtained by photography of the image sensing apparatus 1 is supplied to the external image processing apparatus, so that the external image processing apparatus extracts the selected images and generates the stroboscopic image.

[Note 2]

The image sensing apparatus 1 can be realized by hardware or a combination of hardware and software. In particular, a whole or a part of processes performed by the units illustrated in FIG. 5, 13, 25 or 30 can be constituted of hardware, software, or a combination of hardware and software. If software is used for constituting the image sensing apparatus 1, a block diagram of a portion realized by software indicates a functional block diagram of the portion.

What is claimed is:

1. An image sensing apparatus comprising:
an imaging unit which outputs image data of images obtained by photography; and
a photography control unit which controls the imaging unit to perform sequential photography of a plurality of target images including a specific object as a subject, wherein
the photography control unit sets a photography interval of the plurality of target images in accordance with a moving speed of the specific object.

2. An image sensing apparatus according to claim 1, wherein the moving speed of the specific object is detected on the basis of image data output from the imaging unit before the plurality of target images are photographed.

3. An image sensing apparatus according to claim 2, further comprising an object detection unit which detects, on the basis of image data of a plurality of non-target images output from the imaging unit before the plurality of target images are photographed, a position and a size of the specific object on each non-target image, wherein
the moving speed is detected from the position of the specific object on each non-target image, and
the photography control unit sets the photography interval in accordance with the moving speed and the size of the specific object.

4. An image sensing apparatus according to claim 3, wherein
the photography control unit includes a photography possibility decision unit which decides photography possibility of the plurality of target images,
the photography possibility decision unit derives a moving distance of the specific object during a photography period of the plurality of target images on the basis of the photography interval, the moving speed, and a number of the plurality of target images,
the photography possibility decision unit further derives a movable distance of the specific object on the plurality of target images on the basis of a position of the specific object on a first target image based on a detection result of the object detection unit and a movement direction of the specific object on the plurality of target images based on a detection result of the object detection unit, and
the photography possibility decision unit further decides photography possibility of the plurality of target images on the basis of comparison between the moving distance and the movable distance.

5. An image sensing apparatus according to claim 1, further comprising an image combination unit which extracts an image of a part in which image data of the specific object exists as an extracted image from each target image, and combines a plurality of extracted images that are obtained.

6. An image sensing apparatus comprising:
an imaging unit which outputs image data of images obtained by photography; and
a photography control unit which controls the imaging unit to perform sequential photography of a plurality of frame images including a specific object as a subject, wherein
the photography control unit includes a target image selection unit which selects a plurality of target images from the plurality of frame images on the basis of a moving speed of the specific object.

7. An image sensing apparatus according to claim 6, wherein the moving speed of the specific object is detected on the basis of image data output from the imaging unit before the plurality of target images are photographed.

8. An image sensing apparatus according to claim 7, further comprising an object detection unit which detects, on the basis of image data of a plurality of non-target images output from the imaging unit before the plurality of target images are photographed, a position and a size of the specific object on each non-target image, wherein
the moving speed is detected from the position of the specific object on each non-target image, and
the image selection unit selects the plurality of target images on the basis of the moving speed and the size of the specific object.

9. An image sensing apparatus according to claim 6, further comprising an image combination unit which extracts an image of a part in which image data of the specific object exists as an extracted image from each target image, and combines a plurality of extracted images that are obtained.

10. An image processing apparatus comprising an image selection unit which selects p selected images from m input images among a plurality of input images obtained by sequential photography including a specific object as a subject (m and p denote an integer of two or larger, and m>p holds), wherein
the image selection unit selects the p selected images including i-th and the (i+1)th selected images so that a distance between the specific object on the i-th selected image and the specific object on the (i+1)th selected image becomes larger than a reference distance corresponding to a size of the specific object (i denotes an integer in a range from one to (p−1)).

11. An image processing apparatus according to claim 10, further comprising an object detection unit which detects a position and a size of the specific object on each input image via a tracking process for tracking the specific object on the plurality of input images on the basis of image data of each input image, wherein
the distance between the specific object on the i-th selected image and the specific object on the (i+1)th selected image is a distance based on a detection result of the position by the object detection unit, and
the reference distance is a distance based on a detection result of the size by the object detection unit.

12. An image processing apparatus according to claim 11, wherein
the plurality of input images include a plurality of non-target input images obtained by photography before the m input images, and
the image selection unit detects a moving speed of the specific object on the basis of the position of the specific object on each non-target input image detected by the object detection unit, and performs the selection by using the detected moving speed.

13. An image processing apparatus according to claim 11, wherein the image selection unit detects a moving speed of the specific object on the basis of the position of the specific object on each of the m input images detected by the object detection unit, and performs the selection by using the detected moving speed.

14. An image processing apparatus according to claim 10, further comprising an image combination unit which extracts an image of a part in which image data of the specific object exists as an extracted image from each selected image, and combines a plurality of extracted images that are obtained.

15. An image sensing apparatus comprising:
an imaging unit which outputs image data of images obtained by photography;
a sequential photography control unit which controls the imaging unit to perform sequential photography of a plurality of target images including a specific object as a subject; and
an object characteristic deriving unit which detects a moving speed of the specific object on the basis of image data output from the imaging unit before the plurality of target images are photographed, wherein
the sequential photography control unit sets a sequential photography interval of the plurality of target images in accordance with the detected moving speed.

16. An image sensing apparatus according to claim 15, further comprising an object detection unit which detects, on the basis of image data of a plurality of preimages output from the imaging unit before the plurality of target images are photographed, a position and a size of the specific object on each preimage, wherein
the object characteristic deriving unit detects the moving speed from the position of the specific object on each preimage, and
the sequential photography control unit sets the sequential photography interval in accordance with the moving speed and the size of the specific object.

17. An image sensing apparatus according to claim 16, wherein
the sequential photography control unit includes a sequential photography possibility decision unit which decides sequential photography possibility of the plurality of target images,
the sequential photography possibility decision unit derives a moving distance of the specific object during a photography period of the plurality of target images on the basis of the sequential photography interval, the moving speed, and a number of the plurality of target images,
the sequential photography possibility decision unit further derives a movable distance of the specific object on the plurality of target images on the basis of a position of the specific object on a first target image based on a detection result of the object detection unit and a movement direction of the specific object on the plurality of target images based on a detection result of the object detection unit, and
the sequential photography possibility decision unit further decides sequential photography possibility of the plurality of target images on the basis of comparison between the moving distance and the movable distance.

18. An image sensing apparatus according to claim 15, further comprising an image combination unit which extracts an image of a part in which image data of the specific object exists as an extracted image from each target image, and combines a plurality of extracted images that are obtained.

19. An image processing apparatus comprising:
an image selection unit which selects p selected images from m input images obtained by sequential photography including a specific object as a subject (m and p denote an integer of two or larger, and m>p holds); and
an object detection unit which detects a position and a size of the specific object on each input image via a tracking process for tracking the specific object on the m input images on the basis of image data of each input image, wherein
the image selection unit selects the p selected images including i-th and the (i+1)th selected images so that a distance between the specific object on the i-th selected image and the specific object on the (i+1)th selected image based on a detection result of position by the object detection unit is larger than a reference distance corresponding to the size of the specific object on the i-th and the (i+1)th selected images based on a detection result of size by the object detection unit (i denotes an integer in a range from one to (p−1)).

20. An image processing apparatus according to claim 19, further comprising an image combination unit which extracts an image of a part in which image data of the specific object exists as an extracted image from each selected image, and combines a plurality of extracted images that are obtained.
